(19) United States
(12) Patent Application Publication
(10) Pub. No.: US 2008/0183638 A1
(43) Pub. Date: Jul. 31, 2008

(54) METHOD AND SYSTEM FOR MULTIPLE PORTFOLIO OPTIMIZATION

(75) Inventors: Michael CHIGIRINSKIY, Boston, MA (US); Vitaly SERBIN, Somerville, MA (US); Leonid Alexander ZOSIN, Scarsdale, NY (US); Ananth MADHAVAN, San Francisco, CA (US); Ian DOMOWITZ, New York, NY (US)

Correspondence Address: ROTHWELL, FIGG, ERNST & MANBECK, P.C., 1425 K STREET, N.W., SUITE 800, WASHINGTON, DC, 20005, US

(73) Assignee: ITG SOFTWARE SOLUTIONS, INC., Culver City, CA (US)

(21) Appl. No.: 11/955,078

(22) Filed: Dec. 12, 2007

Related U.S. Application Data
(63) Continuation-in-part of application No. 11/730,750, filed on Apr. 3, 2007.
Application No. 11/730,750 is a continuation-in-part of application No. 10/640,630, filed on Aug. 14, 2003, now Pat. No. 7,337,137.
(60) Provisional application No. 60/448,147, filed on Feb. 20, 2003.
(60) Provisional application No. 60/907,525, filed on Apr. 5, 2007.

(51) Int. Cl. G06Q 40/00

(52) U.S. Cl. 705/36 R

(57) ABSTRACT

Methods and systems for optimizing a plurality of portfolios, each portfolio including one or more shares of one or more tradable assets, and may include the steps of: receiving asset data associated with said plurality of said portfolios; receiving optimization constraints including at least one global constraint defining a constraint to be applied across an aggregate of the plurality of portfolios; receiving one or more objectives to be applied to individual portfolios during optimization; aggregating the optimized portfolio data to create aggregate optimized asset data; determining if the aggregate optimized asset data satisfies the global constraint; and only if said at least one global constraint is satisfied, outputting said optimized asset data.

### CROSS REFERENCE TO RELATED PATENT DOCUMENTS

This application is a continuation-in-part of U.S. patent application Ser. No. 11/730,750, entitled “Method and System For Multiple Portfolio Optimization,” filed on Apr. 3, 2007, which is a continuation-in-part of U.S. patent application Ser. No. 10/640,630, filed on Aug. 14, 2003, which claims priority to U.S. Provisional Application Ser. No. 60/448,147 filed on Feb. 20, 2003. This application also claims priority to U.S. Provisional Application Ser. No. 60/907,525, filed on Apr. 5, 2007. The entire contents of each of these applications are incorporated herein by reference.

### BACKGROUND OF THE INVENTION

1. Field of the Invention

The present invention relates to methods and systems for optimization of a plurality of portfolios made up of tangible or intangible assets. More specifically, the present invention relates to methods and systems for optimization of multiple portfolios while applying portfolio constraints.

2. Discussion of the Background

Managers of assets, such as portfolios of stocks and/or other assets, often seek to maximize returns on an overall investment, such as, e.g., for a given level of risk as defined in terms of variance of return, either historically or as adjusted using known portfolio management techniques.

Following the seminal work of Harry Markowitz in 1952, mean-variance optimization has been a common tool for portfolio selection. A mean-variance efficient portfolio can be constructed through an optimizer with inputs from an appropriate risk model and an alpha model. Such a portfolio helps ensure higher possible expected returns (e.g., net of taxes and subject to various constraints) for a given level of risk.

Risk lies at the heart of modern portfolio theory. The standard deviation (e.g., variance) of the rate of return of an asset is often used to measure the risk associated with holding the asset. However, there can be other suitable or more suitable measures of risk than the standard deviation of return. A common definition of risk is the dispersion or volatility of returns for a single asset or portfolio, usually measured by standard deviation. ITG, the assignee of the present invention, has developed a set of risk models for portfolio managers and traders to measure, analyze and manage risk in a rapidly changing market. (See e.g., application Ser. No. 10/640,630). These models can be used to, among other things, create mean-variance efficient portfolios in combination with a portfolio optimizer, such as, e.g., those set forth herein.

According to modern portfolio theory, for any portfolio of assets (such as, e.g., stocks and/or other assets) there is an efficient frontier, which represents variously weighted combinations of the portfolio's assets that yield the maximum possible expected return at any given level of portfolio risk.

In addition, a ratio of return to volatility that can be useful in comparing two portfolios in terms of risk-adjusted return is the Sharpe Ratio. This ratio was developed by Nobel Laureate William Sharpe. Typically, a higher Sharpe Ratio value is preferred. A high Sharpe ratio implies that a portfolio or asset (e.g., stock) is achieving good returns for each unit of risk. The Sharpe Ratio can be used to compare different assets or different portfolios. Often, it has been calculated by first subtracting the risk free rate from the return of the portfolio, and then dividing by the standard deviation of the portfolio. The historical average return of an asset or portfolio can be extremely misleading, and should not be considered alone when selecting assets or comparing the performance of portfolios. The Sharpe Ratio allows one to factor in the potential impact of return volatility on expected return, and to objectively compare assets or portfolios that may vary widely in terms of returns.

By connecting a portfolio to a single risk factor, Sharpe simplified Markowitz's work. Sharpe developed a heretical notion of investment risk and reward—a sophisticated reasoning that has become known as the Capital Asset Pricing Model (CAPM). According to the CAPM, every investment carries two distinct risks. One is the risk of being in the market, which Sharpe called “systematic risk.” This risk, also called “beta,” can be reduced by diversification. The other risk, “unsystematic risk,” is specific to a company's fortunes. These risks can also be mitigated through appropriate diversification. Sharpe discerned that a portfolio's expected return hinges solely on its “beta,” its relationship to the overall market. The CAPM helps measure portfolio risk and the return an investor can expect for taking that risk.

Portfolio optimization often involves the process of analyzing a portfolio and managing the assets within it. Typically, this is done to obtain the highest return given a particular level of risk. Portfolio optimization can be conducted on a regular, periodic basis, e.g., monthly, quarterly, semi-annually or annually. Likewise, one can rebalance portfolios, which is accomplished ultimately by changing the composition of the assets in a portfolio, as often as is desired or necessary. Since one is not required to rebalance a portfolio each time one optimizes, one can optimize as frequently as desired. In considering rebalancing decisions, one typically also considers tax and/or transaction cost implications of selling and buying as one pursues an optimal portfolio.

In some existing portfolio optimizers, techniques such as “hill climbing” or linear/quadratic programming are used to find optimal solutions. However, when using these techniques, issues such as long/short, minimum position size, position count constraints, tax costs, and transaction costs generally cannot be modeled accurately. In addition, U.S. Pat. No. 6,003,018, titled Portfolio Optimization By Means Of Resampled Efficient Frontiers, shows other optimizer methods. The entire disclosure of U.S. Pat. No. 6,003,018 is incorporated herein by reference. The present invention provides substantial improvement over these and other optimizers.

The present assignee has developed a portfolio optimizer, currently called the ITGOpt®) optimizer, which uses mixed integer programming (MIP) technology to produce more accurate results than previously used optimization and rebalancing systems. In a prior version, of ITGOpt®, the system performed optimization in a single pass, taking into account simultaneously all of the constraints and parameters. In that version, characteristics related to the trading of a particular security could be constrained or introduced. In addition, a full range of portfolio characteristics could have been specified, including, for example, constraints on leverage, turnover, and long versus short positions. Furthermore, constraints may be applied to an entire portfolio or to its long or short sides individually. Furthermore, the prior version of ITGOpt® avoided misleading heuristics by combining a branch-and-bound algorithm with objective scoring of potential solutions, thus reducing the size of the problem without damaging the integrity of the outcome.

Additionally, the prior ITGOpt® optimizer could accurately model and analyze implications associated with the tax code. For example, integer modeling of tax brackets and tax lots enables the ITGOpt®) optimizer to minimize net tax liability without discarding large blocks of profitable shares. The prior ITGOpt® is also adaptable to high in first out (HIFO), last in first out (LIFO), or first in first out (FIFO) accounting methods. In addition, the prior ITGOpt® was designed with a focus on the real-world complexities of sophisticated investment strategies. The prior ITGOpt®) optimizer was able to handle complex and/or non-linear issues that could arise in real-world fund management.

Additionally, the prior ITGOpt® optimizer was able to factor transaction costs resulting from market impact into its solutions. The optimizer included a cost model, ACE®, for forecasting market impact. The inclusion of ACE® enabled users to weigh implicit transaction costs along with risks and expected returns of optimization scenarios.

It is common, especially in quantitatively managed portfolios, to control trading costs through constraints on the quantity of shares traded or the expected cost to trade when rebalancing a portfolio. One method of estimating the expected cost to trade is to use a mathematical model, such as ITG's ACE® (see U.S. patent application Ser. No. 10/166,719, entitled “System and method for estimating and optimizing transaction costs,” the entire contents of which are incorporated herein by reference).

The constraints placed on the quantity of shares traded or expected costs are reasonably effective when applied to the management of a single portfolio. However, many portfolio managers oversee multiple portfolios that might have overlapping holdings. The rebalancing of multiple portfolios can cause a problem in that the one stock found in more than one portfolio may want to be traded in more than one portfolio. For example, portfolios A and B can both contain the same share of IBM stock, and in rebalancing portfolios A and B it may be desirable to trade the IBM share in each portfolio. A manager attempting to trade the aggregate number of shares that are contained in multiple portfolios will count a single share found in multiple portfolios multiple time resulting in a larger overall execution size and larger than expected trade costs. For example, a manager would find that two shares of IBM need to be traded in portfolios A and B, and thus might execute the trading of two shares of IBM rather than the single IBM share that is in both portfolios A and B. The result of this “multiple counting” of shared shares is that each portfolio's realized execution cost will be greater than the portfolio manager is willing or expecting to spend.

Additionally, the prior ITGOpt® optimizer used effective historical back-testing. The ITGOpt® optimizer could closely track portfolios through time, accounting for the effects of splits, dividends, mergers, spin-offs, bankruptcies and name changes as they occur.

Additionally, the prior ITGOpt® optimizer was equipped to handle many funds and many users. The prior ITGOpt® optimizer included multi-user, client-server relational database management technology having the infrastructure to accommodate the demands of many simultaneous users and a large volume of transactions.

Additionally, the prior ITGOpt® optimizer integrated neatly with trade-order management and accounting systems. Because the prior ITGOpt® optimizer was built on relational database management technology it was easily linked with other databases. The prior ITGOpt® optimizer could also generate trade lists for execution by proprietary TOM systems. Moreover, the prior ITGOpt® optimizer design allowed for extensive customization of reports to fit a companies' operations and clients' needs. Moreover, custom report formats were able to be designed quickly and cost-effectively.

While a variety of portfolio optimization systems and methods, including prior versions of ITGOpt® optimization system, may exist, there is a significant need in the art for systems and processes that improve upon the above and/or other systems and processes.

### SUMMARY OF THE INVENTION

The various embodiments of the present invention significantly improve upon existing methods and systems.

According to embodiments of the present inventions, improved systems and methods are provided for the optimization of a plurality of portfolios which are composed of assets, either tangible or intangible, such as securities or stocks.

In an embodiment of the invention, a method is provided for optimizing a plurality of portfolios. Each portfolio includes one or more shares of one or more tradable assets. The method includes receiving asset data defining a plurality of portfolios; receiving one or more individual portfolio optimization parameters corresponding to the plurality of portfolios; receiving one or more global optimization parameters; for each portfolio, optimizing the asset data based on the corresponding individual optimization parameters; aggregating the optimized asset data to create aggregate optimized asset data; determining if the aggregate optimized asset data satisfies the global optimization parameters; and only if the global optimization parameters are satisfied, outputting the optimized asset data.

In another embodiment of the invention, a computer-readable storage medium is provided that has computer executable program code stored therein for optimizing a plurality of portfolios by performing the following operations: receiving asset data defining a plurality of said portfolios; receiving asset data defining a plurality of portfolios; receiving one or more individual portfolio optimization parameters corresponding to the plurality of portfolios; receiving one or more global optimization parameters; for each portfolio, optimizing the asset data based on the corresponding individual optimization parameters; aggregating the optimized asset data to create aggregate optimized asset data; determining if the aggregate optimized asset data satisfies the global optimization parameters; and only if the global optimization parameters are satisfied, outputting the optimized asset data.

In another embodiment of the invention, a system is provided for performing optimization of a plurality of portfolios of assets. The system may include a client interface configured to receive asset data defining a plurality of portfolios, to receive one or more individual portfolio optimization parameters corresponding to one or more of a plurality of portfolios, to receive one or more global optimization parameters, to optimize each portfolio of a plurality of portfolios using said asset data and a corresponding one or more of the individual optimization parameters, to aggregate the optimized asset data to create aggregate optimized asset data; to determine if the aggregate optimized asset data satisfies the one or more global optimization parameters; and only if the one or more global optimization parameters is satisfied, to output the optimized asset data.

The above and/or other aspects, features and/or advantages of various embodiments will be further appreciated in view of the following description in conjunction with the accompanying figures. Various embodiments can include or exclude different aspects, features, or advantages where applicable. In addition, various embodiments can combine one or more aspects, features, or advantages where applicable. The descriptions of the aspects, features, or advantages of a particular embodiment should not be construed as limiting any other embodiment of the claimed invention.

### BRIEF DESCRIPTION OF THE DRAWINGS

The accompanying figures are provided by way of example, without limiting the broad scope of the invention or various other embodiments, wherein:

FIG. 1 is a flow diagram illustrating a process according to some embodiments of the invention;

FIG. 2 is another flow diagram illustrating a process according to some embodiments of the invention;

FIG. 3 illustrates computer(s) that can be used to, among other things, implement process steps in various embodiments of the invention;

FIG. 4 illustrates computer system(s) that can be used to, among other things, implement process steps in various embodiments of the invention;

FIG. 5 is a schematic diagram illustrating database management structure according to some embodiments;

FIG. 6 is an illustrative graph of return (e.g., in millions of dollars) verses risk (e.g., in millions of dollars) for, e.g., finding an optimal portfolio;

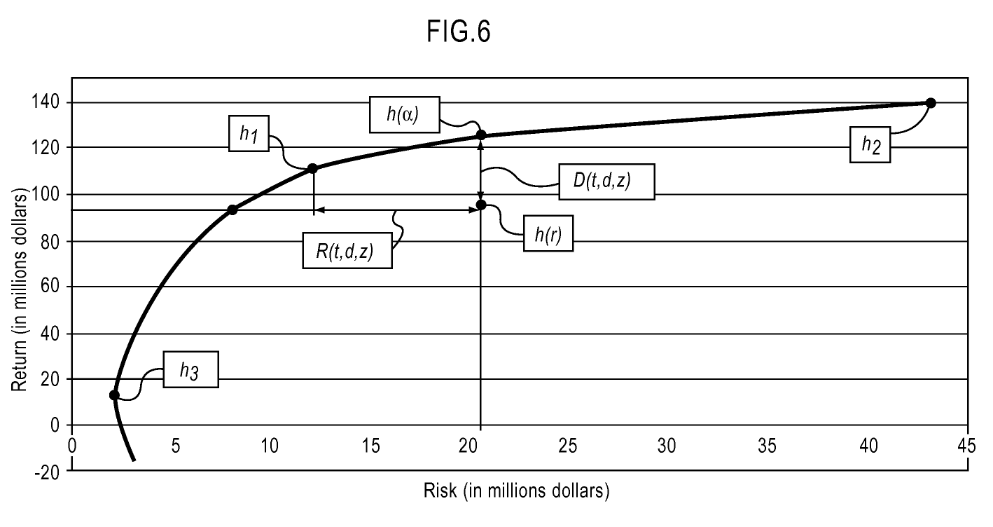

FIG. 7 is an illustrative graph of return (e.g., in millions of dollars) verses risk (e.g., in millions of dollars) showing, e.g., a set of mean-variance points that deviate from the mean-variance efficient frontier according to some illustrative embodiments of the invention;

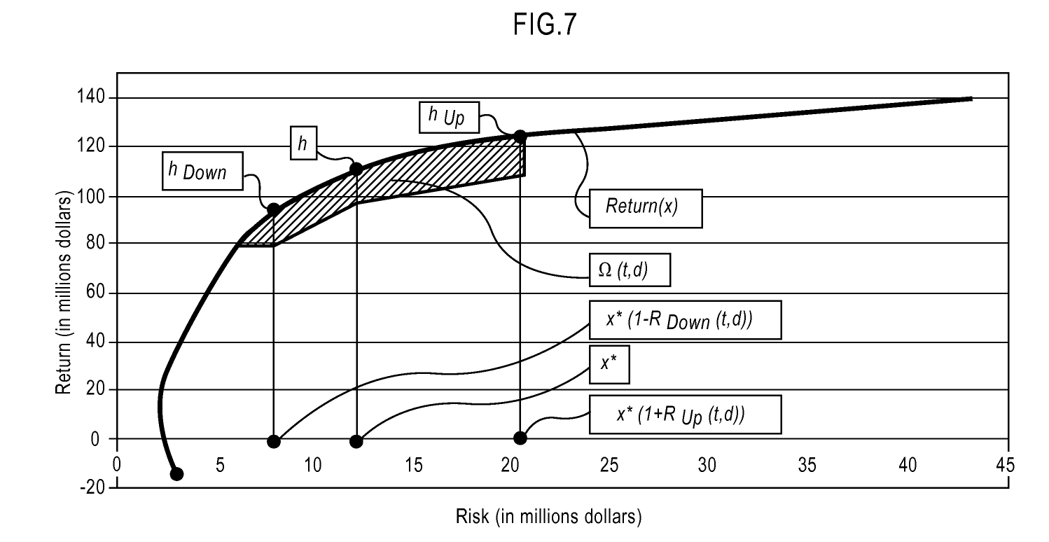

FIG. 8 is flow diagram illustrating the process of optimization of multiple portfolios; and

FIG. 9 is a flow diagram illustrating the adjusting of constraints during subsequent rounds of multiple portfolio optimization.

FIG. 10 is a flow diagram illustrating the process of optimization of multiple portfolios by “punishing” objectives or the individual portfolios.

FIG. 11 is a chart illustrating a comparison of optimization methods that apply global constraints and objectives in Example 1.

FIG. 12 is a chart illustrating a comparison of shares traded resulting from optimization methods that apply global constraints and objectives in Example 1.

FIG. 13 is a chart illustrating a comparison of optimization methods that allow crossing and apply global constraints and objectives in Example 2.

FIG. 14 is a chart illustrating a comparison of optimization methods that do not allow crossing and apply global constraints and objectives in Example 2.

### DETAILED DESCRIPTION OF THE PREFERRED EMBODIMENTS

The embodiments of the invention can be implemented on one or more computer(s) and/or one or more network of computer(s), such as a local area network (LAN), a wide area network (WAN), the Internet and/or another network. In various embodiments, one or more server(s), client computer(s), application computer(s) and/or other computer(s) can be utilized to implement one or more aspect of the invention. Illustrative computers can include, e.g.: a central processing unit; memory (e.g., RAM, etc.); digital data storage (e.g., hard drives, etc.); input/output ports (e.g., parallel and/or serial ports, etc.); data entry devices (e.g., key boards, etc.); etc. Client computers may contain, in some embodiments, browser software for interacting with the server(s), such as, for example, using hypertext transfer protocol (HTTP) to make requests of the server(s) via the Internet or the like.

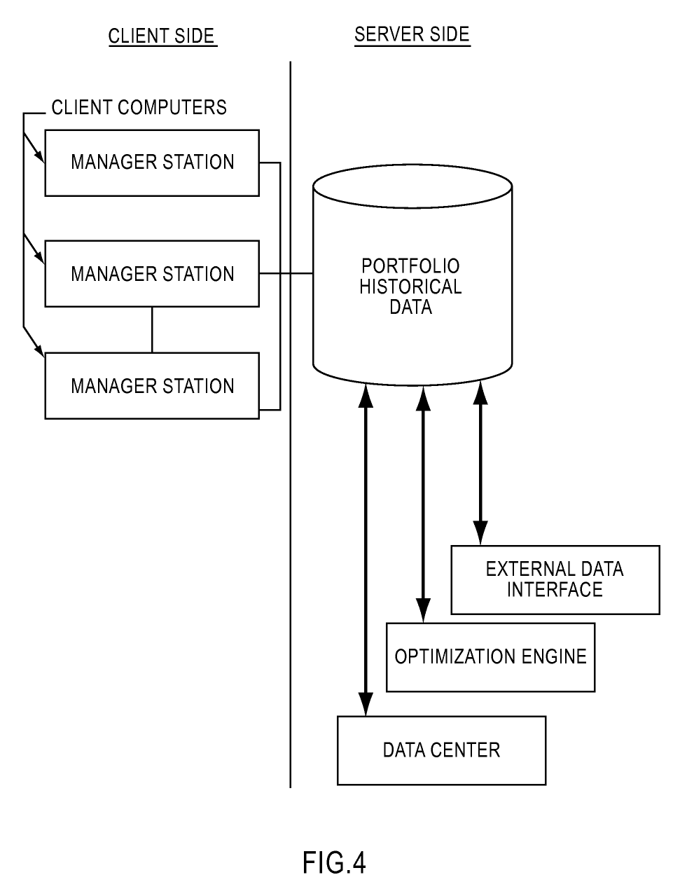

In some embodiments, the system can utilize relational databases, such as, e.g., employing a relational database management system (RDBMS) program to create, update and/or administer a relational database. The RDBMS may take Structured Query Language (SQL) statements entered by a user or contained in an application program and creates, updates and/or provides access to database(s). Some illustrative RDBMS's include ORACLE's database product line and IBM's DB2 product line. In some illustrative embodiments, as shown in FIG. 4, one or more client computers can be provided, such as, e.g., a LAN-based system. The client computer(s) can include an appropriate operating system, such as, for example, WINDOWS NT or another system. In some embodiments, the system is adapted to provide an object based graphical user interface (GUI).

In some embodiments, the system provides a multi-user client server system, such as shown in FIG. 4. In some embodiments, the system provides a hierarchical, object-based portfolio control structure for managing variants of a core set of strategies. In some embodiments, data based can include holdings, trades, prices, corporate actions and others. In some embodiments, multiple risk models may be employed, such as, e.g., those available from BARRA, NORTHFIELD, custom models and others.

In some embodiments, portfolios include data objects, such as, e.g., holdings, historical executions, universe, benchmark, risk model, market data and/or others. In some embodiments, a universe of selected stocks can include, e.g., all of the relatively active securities in a relevant market or the like. Assuming, for example, that the U.S. market is the relevant market, then the universe of selected stocks may comprise, in some embodiments, approximately 8,000 stocks, including stocks from the New York Stock Exchange, the American Stock Exchange, the NASDAQ National Market, and some small cap stocks. Preferably, the specific objects in a portfolio can be defined by attributes and/or parameters that are set by a user. In some embodiments, an instance of a portfolio can be generated on the basis of an analysis date attribute, such as, in one illustrative example: a 3% S&P tracking portfolio with a Russell 1000 universe as of Jan. 1, 2003.

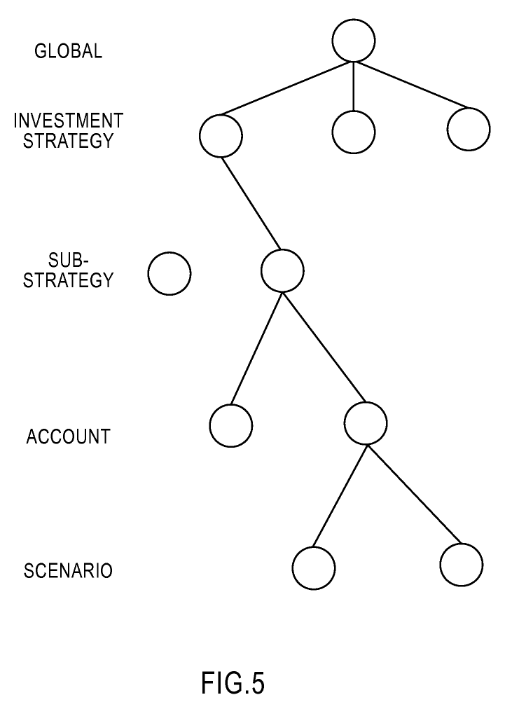

In some embodiments, the portfolio database can include an attributes hierarchy, such as, for example, a five level hierarchy as illustratively shown in FIG. 5. In some illustrative embodiments, the lower levels may inherit attributes of higher levels. Additionally, the lower levels can preferably override inherited attributes.

In some embodiments, the portfolio database can include characteristics that can be, e.g., arbitrary stock specific data. Preferably, users can define characteristics, such as using formulas and/or rules to create new characteristics from other characteristics. As an illustrative example, a user could use algebraic creation methods, such as “A=B+C×D.” As another illustrative example, a user could use set membership methods, such as, e.g., “A+1 if B<C and B>D.” In some embodiments, filters can be provided to enable names to be removed from a universe for compliance and/or other reasons, such as, e.g., “remove sin stocks with p/e's>10 and price<5.” In some embodiments, the system can provide default values for characteristics that are not specified.

In some embodiments, users can construct customized reports, such as, e.g., customized asset level reports. Preferably, report definitions can be named and stored (e.g., in digital data storage).

In some embodiments, any dimension of a portfolio “space” can be part of an objective function or constraint. In some embodiments, the system can facilitate the exploring of tradeoffs between any combinations of, for example: expected return; risk/tracking; exposures; transaction costs; taxes; position/trade counts/sizes; and others.

In some embodiments, one optimization can be provided with a universe in which both sides (e.g., buy and sell sides) are rebalanced subject to constraints on each side individually and for the portfolio as a whole.

In some embodiments, users are provided with a graphical user interface that is presented to the users via client computers. In some embodiments, the graphical user interface can enable importing and/or exporting of data and files, the setting of parameters, the running of the optimization and/or the acceptance of optimization results. In some embodiments, users can create or import specific task schedules in which, for example, import and/or export of data can be automated and functionality available in the user interface is available in batch processing.

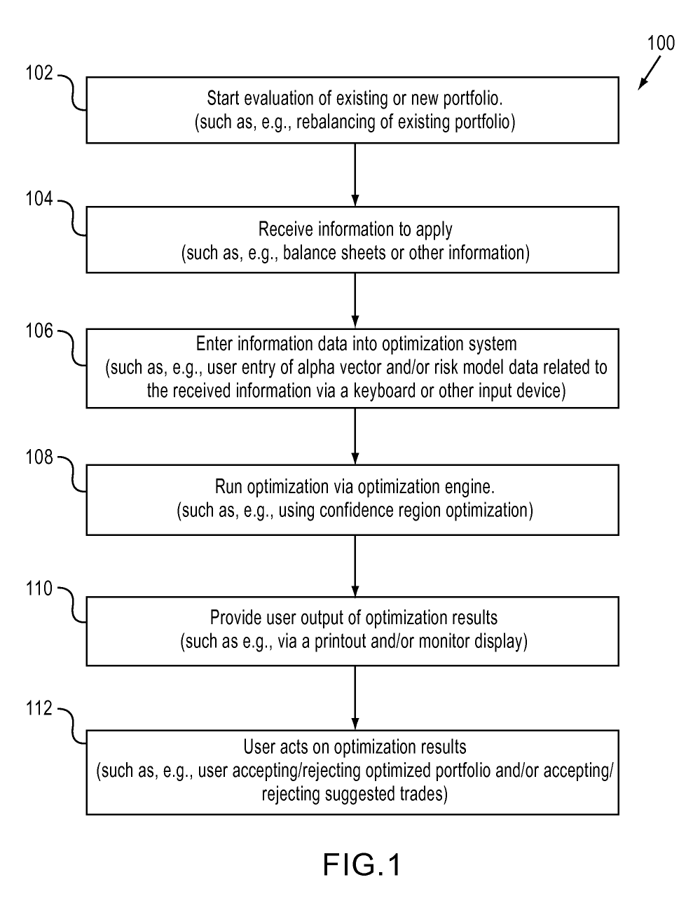

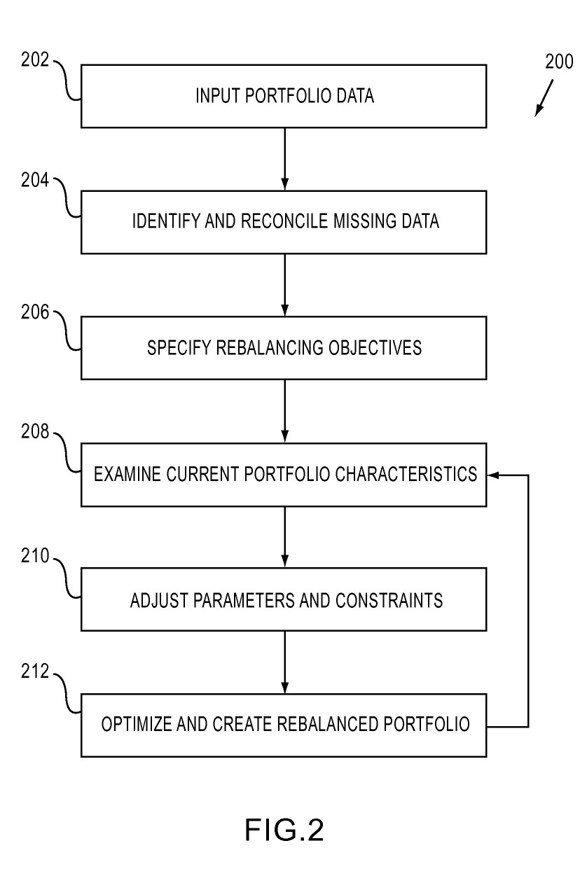

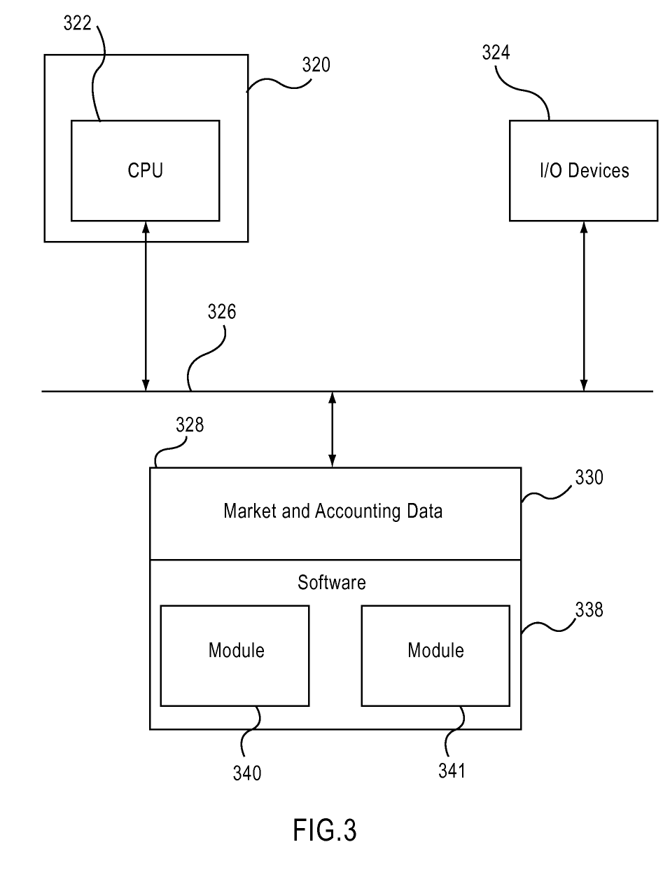

FIG. 3 illustrates an example of a computer arrangement that can be used to implement computerized process steps, such as, e.g., within processes 100 and 200 shown in FIGS. 1 and 2. In some embodiments, computer 320 includes a central processing unit (CPU) 322, which can communicate with a set of input/output (I/O) device(s) 324 over a bus 326. The I/O devices 324 can include, for example, a keyboard, mouse, video monitor, printer, and/or other devices.

The CPU 322 can communicate with a computer readable medium (e.g., conventional volatile or non-volatile data storage devices) 328 (hereafter “memory 328”) over the bus 326. The interaction between a CPU 322, I/O devices 324, a bus 326, and a memory 328 can be like that known in the art.

Memory 328 can include, for example, market and accounting data 330, which can include, for example, data on stocks, such as, stock prices, and data on corporations, such as book value. The memory 328 can also store software 338. The software 338 can include a number of modules 340 for implementing the steps of processes, such as steps of the processes 100 and/or 200 shown in FIGS. 1 and 2. Conventional programming techniques may be used to implement these modules. Memory 328 can also store the above and/or other data file(s).

In some embodiments, the various methods described herein may be implemented via a computer program product for execution on one or more computer systems. For example, a series of computer instructions can be stored on a computer readable medium (e.g., a diskette, a CD-ROM, ROM or the like) or transmitted to a computer system via and interface device, such as a modem or the like. The medium may be substantially tangible (e.g., communication lines) and/or substantially intangible (e.g., wireless media using microwave, light, infrared, etc.). The computer instructions can be written in various programming languages and/or can be stored in memory device(s), such as semiconductor devices (e.g., chips or circuits), magnetic devices, optical devices and/or other memory devices. In the various embodiments, the transmission may use any appropriate communications technology.

FIGS. 1 and 2 illustrate process steps that may be carried out in some illustrative embodiments of the invention. These two processes are illustrative and various embodiments of the invention can be applied in various processes.

With respect to the illustrative process 100 shown in FIG. 1, in a first step 102, the process initiates the evaluation of an existing or new portfolio. Then, in a second step 104, the system receives information to apply into the optimization analysis. Then, in a third step 106, information is entered into an optimization system, such as an optimization engine. Then, in a forth step 108, optimization algorithms and methodologies are executed via an optimization engine. Then, in a fifth step 110, optimization results are provided to a user. Then, in a sixth step 112, the user acts on the optimization results. For example, the user might, e.g., rebalance a portfolio based on the results.

With respect to the illustrative process 200 shown in FIG. 2, in a first step 202, a user can input portfolio data. In some embodiments, a user can create a portfolio with a portfolio name editor. Preferably, the user can load data as needed using file import/export utilities, such as, e.g.: identifier map; holdings, benchmarks, universes, characteristics, risk models and/or others. Preferably, a user can also define portfolio attributes with a parameter editor, such as, e.g.: analysis date; benchmark; universe; characteristics; risk model. Preferably, a user can also scrub data.

Then, at step 204, a user can identify and reconcile missing data. In some embodiments, a user can reconcile data from multiple sources. In some embodiments, some potential problems could include: changes in asset status or identifier; missing or erroneous characteristics or risk data; membership in benchmark or universe; and/or others. In some embodiments, a holdings summary report can provide high-level problem notification. In some embodiments, missing data reports can be used for: holdings; benchmark; universe; characteristics; factor exposures; and/or others. In some embodiments, a user can use data editors to fix problems.

Then, at step 206, a user can specify rebalancing objectives. In some embodiments, a user can select “standard” parameters using a parameter editor, such as, for example: cash flow; objective function (e.g., alpha, risk aversion); risk constraints (e.g., two or plural benchmarks, common factor and specific); cash balance, turnover constraints; position size, position count and/or trade size constraints; universe characteristics filter; and/or others. Preferably, a user can select user specific parameters for use in the processes of the present invention. Preferably, a user can construct a constraint matrix using row/column bounds editors.

Then, at step 208, a user can examine current portfolio characteristics. In some embodiments, a user can receive reports for one or more of: holdings, universe, benchmarks, final portfolio(s), and/or others. Preferably, a user can receive summary and detail related to: accounting, characteristics, factor exposure, trades, and/or others.

Then, at step 210, a user can adjust parameters and constraints. In some embodiments, a user can perform this step via a parameter editor. Preferably, a row/column bounds editor is provided.

Then, at step 212, a user can optimize and create a rebalanced portfolio. This step can utilize an optimization engine to optimize and create suggested portfolios/trades. Preferably, the user can then examine the suggested portfolio/trades via, for example, a trade summary screen or report, a trade detail report or the like. The user can then preferably edit the suggested portfolio/trades as needed. The user can then preferably incorporate suggested portfolios/trades into particular executions.

As shown by arrow A2, the user can repeat steps 208-212 as desired to continuously evaluate portfolios/trades, rebalance portfolios and the like.

In some embodiments of the invention, step 108 in the process shown in FIG. 1 and/or step 212 in the process shown in FIG. 2 can include optimization methodologies as described below. In order to implement these methodologies, in some embodiments an optimizer (created, e.g., via software or the like) can include software modules or the like that effect steps as set forth below.

In some embodiments of the invention, a portfolio optimizer can be provided that enables one to ascertain an acceptable region of error. This can be advantageous, e.g., to help avoid having an optimizer that might propose changes or trades to be made as a result of “noise” within various inputs, which could, potentially, result in numerous trades and various costs related thereto. In some embodiments of the present invention, with an understanding of approximately how noisy these inputs are, the system can discern how large a region a portfolio manager can remain within that is deemed to be acceptable.

In some embodiments, the optimizer can define a confidence region for a portfolio P₀ on the efficient frontier that corresponds to a risk aversion γ. In some embodiments, this region includes all portfolios P, such that c_{low}*Risk(P₀)<Risk(P)<c_{high}*Risk(P₀) and Ret(P)>c*Ret(Pₒₚₜ). Where Pₒₚₜ is a portfolio on the efficient frontier such that Risk(Pₒₚₜ)=Risk(P). Additionally, c_{low}, c_{high} and c are relative average deviations of decrease in risk, increase in risk and expected return of optimal portfolios that correspond to the risk aversion γ and different vectors of returns. It can be assumed that vectors of returns are normally distributed around their mean. In some embodiments, a user is able to set a specific confidence level by setting different values for constants c_{low}, c_{high} and c.

In the resampled efficient portfolio optimization of the '018 patent, discussed above, a confidence region is computed around a resampled efficient frontier portfolio P₀ and includes all portfolios with a value of variance relative to P₀ less than or equal to a value associated with a specified confidence level. There, a main point in the resampled efficient portfolio optimization is to compute resampled efficient frontier portfolios. The resampling process produces simulated returns that provide alternative inputs for a computing of efficient frontier portfolios. Resampled efficient frontier portfolios are the result of an averaging process across many possible efficient frontiers.

On the other hand, in some embodiments of the present invention, standard efficient frontier portfolios are used, rather than resampled efficient frontier portfolios. Among other things, an efficient frontier portfolio, in contrast to a resampled efficient frontier portfolio, can be defined as a portfolio with maximum expected return for a fixed value of risk. In many cases, it should not be appropriate to use a resampled efficient frontier. As merely one illustrative example, consider two assets with a correlation coefficient of zero, expected returns 10% and 20% and a standard deviation of returns 20%. The maximum return portfolio includes only second asset and its expected return will be 20%. The resampled portfolio, which corresponds to the maximum return point on the resampled efficient frontier, includes about 35% of the first asset and 65% of the second asset and its expected return is only about 16%.

Resampled efficient frontier portfolios are constructed by averaging many portfolios that were obtained through simulations. Therefore, in most cases, these portfolios include a large number of different assets. Among other things, there would be difficulties using such portfolios in cases where it is desirable to have an optimal portfolio with a limited number of assets from a universe.

Computing Confidence Region for the Mean-Variance Efficient Set In Some Embodiments:

### I. Definitions and Assumptions:

In some embodiments, the main parameters of the mean-variance model in ITG/Opt are α—the vector of assets expected returns and Σ—covariance matrix of the assets returns. These parameters can be estimated using historical data, analytical models, analysts' forecasts, or other methods.

V. K. Chopra, “Mean-Variance Revisited: Near-Optimal Portfolios and Sensitivity to Input Variations,” Journal of Investing, 1993, the entire disclosure of which is incorporated herein by reference, illustrates, among other things, that small changes in the input parameters can result in large change in composition of the optimal portfolio. M. Best and R. Grauer, “On the Sensitivity of Mean-Variance Efficient Portfolios to Changes in Asset Means: Some Analytical and Computational Results,” Review of Financial Studies, 1991, the entire disclosure of which is incorporated herein by reference, discusses, among other things, the effect of changes in the vector of assets expected returns on the mean-variance efficient frontier and the composition of optimal portfolios. V. K. Chopra and W. T. Ziemba, “The Effect of Errors in Means, Variances and Covariances on Optimal Portfolio Choice,” Journal of Portfolio Management, 1993 and J. G. Kallberg and W. T. Ziemba, “Mis-specification in Portfolio Selection Problems,” Risk and Capital, ed. G. Bamberg and A. Spreman, Lecture Notes in Economics and Mathematical Sciences, 1984, the entire disclosures of which are incorporated herein by reference, discuss, among other things, the relative importance of errors in expected returns, specific variances and covariances of returns on the investor's utility function. The relative impact of errors in these parameters depends on the investor's risk tolerance. If risk aversion parameter is not too high, the errors in expected returns have much more significant impact on the utility function than errors in other parameters. There are two possible ways to model errors in α:
relative error model: rᵢ=αᵢ*(1+d*zᵢ), where rᵢ is a real expected return of the asset i, αᵢ is an estimated expected return of the asset i, d is a standard deviation of error and zᵢ is a normal random variables with mean 0 and standard deviation 1;
absolute error model is: rᵢ=αᵢ+d*zᵢ, where rᵢ is a real expected return of the asset i, αᵢ is an estimated expected return of the asset i, d is a standard deviation of error and zᵢ is a normal random variables with mean 0 and standard deviation 1.

According to the CAPM model, assets with higher returns have higher risk or higher variance of returns. Therefore, the errors in estimations of expected returns should be proportional to the values of the expected return. Taking into account the last observation, we consider in some embodiments the relative error model.

### II. Confidence Region for the Mean-Variance Efficient Set:

Considering a standard portfolio optimization problem arising in some embodiments:

$${max}_{h ∈ Q} [ {α}^{T} h - γ * Risk ( h ) ] , \qquad ( 1 )$$

where γ is a risk aversion parameter, α is a vector of estimated expected returns, h is a vector of position dollars, Risk(h) is a risk function and Q is a set of feasible portfolios. If γ is close to infinity, the problem (1) is equivalent to the problem:

$${max}_{h ∈ Q} [ - Risk ( h ) ] . \qquad ( 2 )$$

If (is close to 0, the problem (1) is equivalent to the problem:

$${max}_{h ∈ Q} {α}^{T} h . \qquad ( 3 )$$

“t” denotes a return versus risk tradeoff coefficient:

$$t = \frac{{α}^{T} ( h ( 1 ) - h ( 3 ) )}{{α}^{T} ( h ( 2 ) - h ( 3 ) )} , \qquad ( 4 )$$

where h(1), h(2) and h(3) are optimal solutions for problems (1), (2) and (3) correspondingly.

Considering a modified optimization problem with a vector of real expected returns:

$${max}_{h ∈ Q} [ {r}^{T} h - γ * Risk ( h ) ] , \qquad ( 5 )$$

where r is a vector of real expected returns. Let h(r) be an optimal portfolio for the problem (5). If the real return vector is (, the return of this portfolio is (Th(r). We find an optimal portfolio h(( ) with respect to return vector (and with the same level of risk like h(r) has:

$$h ( α ) = Arg {max}_{\{ h \vert h ∈ Q ⋀ Risk ( h ) == Risk ( h ( r ) ) \}} {α}^{T} h . \qquad ( 6 )$$

The relative difference in returns of portfolios h(r) and h(( ) is a function of t, d and z:

$$D ( t , d , z ) = \frac{{α}^{T} ( h ( α ) - h ( r ) )}{{α}^{T} h ( α )} . \qquad ( 7 )$$

The relative difference in Risk of portfolios h(1) and h(r) is a function of γ, d and z:

$$R ( t , d , z ) = \frac{Risk ( h ( 1 ) ) - Risk ( h ( r ) )}{Risk ( h ( 1 ) )} . \qquad ( 8 )$$

The variable z is a normal random variable, so an expected relative return difference of portfolios h(r) and h(α) is a function of t, d:

δ(t,d)=E_{z}(D(t,d,z)) (9)

An optimal portfolio, that corresponds to a high-risk aversion, is close to the minimum variance portfolio, and is much less affected by errors in the expected return vector than an optimal portfolio, that corresponds to a low risk aversion. The function δ(t,d) is equal 0 when t is 0, and it is increasing with increasing of t. Similarly, the function δ(t,d) is equal 0 when d is 0, and it is increasing with increasing of d.

R_{Up} denotes an expected relative increase in Risk:

R_{Up}(t,d)=E_{z}|(−R(t,d,z)|R(t,d,z)<0), (10)

And, we denote by R_{Down} an expected relative decrease in Risk:

R_{Down}(t,d)=E_{z}(R(t,d,z)|R(t,d,z)≧0). (11)

Function Return(x) describe a mean-variance efficient frontier for a vector of expected returns α and a risk function Risk(h), where value Return(x) is a return of an optimal portfolio with variance x. Now, for a given point (x*,Return(x*)) on the mean-variance efficient frontier, that corresponds to a tradeoff coefficient t, and for a standard deviation d, we define a set of points Ω(t,d):

$$Ω ( t , d ) = \{ ( x , y ) \vert \begin{matrix}x \leq {x}^{*} ( 1 + {R}_{Up} ( t , d ) ) , \\ y \geq Return ( {x}^{*} ( 1 - {R}_{Down} ( t , d ) ) ) * ( 1 - δ ( t , d ) ) , \\ y \geq Return ( x ) * ( 1 - δ ( t , d ) ) .\end{matrix} \qquad ( 12 )$$

Intuitively, it will be a set of mean-variance points that deviate from the mean-variance efficient frontier not more than the most of the optimal portfolios that were obtained for different realizations of vector of expected returns.

### III. Estimation of Functions δ, R_{Up} and R_{Down}:

It is possible, for example, estimate functions δ, R_{Up} and R_{Down} for all possible combinations of, e.g., 10 values of the tradeoff coefficient t with 10 values of the standard deviation of error d using Monte Carlo simulations. The results of the study can be, e.g., summarized in tables. Tables 1-3 below demonstrate some illustrative tabular results. In order to calculate, e.g., a function for specific values x and y of tradeoff and standard deviation we can find values t1 and t2 of the tradeoff and two values d1 and d2 of the standard deviation in the table such that t1≦x≦t2 and d1≦y≦d2.

TABLE 1
δ(t, d)

| | t | | | | | | | | | | | |
|---|---|---|---|---|---|---|---|---|---|---|---|---|
| d | 0 | 0.05 | 0.15 | 0.25 | 0.35 | 0.45 | 0.55 | 0.65 | 0.75 | 0.85 | 0.95 | 1 |
| 0 | 0 | 0 | 0 | 0 | 0 | 0 | 0 | 0 | 0 | 0 | 0 | 0 |
| 0.1 | 0 | 0.0009 | 0.0060 | 0.0049 | 0.0076 | 0.0081 | 0.0111 | 0.0117 | 0.0129 | 0.0159 | 0.0168 | 0.0223 |
| 0.2 | 0 | 0.0063 | 0.0121 | 0.0222 | 0.0284 | 0.0301 | 0.0341 | 0.0399 | 0.0450 | 0.0500 | 0.0669 | 0.0769 |
| 0.3 | 0 | 0.0223 | 0.0299 | 0.0501 | 0.0584 | 0.0626 | 0.0616 | 0.0731 | 0.0830 | 0.0870 | 0.1061 | 0.1149 |
| 0.4 | 0 | 0.0313 | 0.0564 | 0.0828 | 0.0908 | 0.0850 | 0.0883 | 0.1012 | 0.1095 | 0.1162 | 0.1289 | 0.1339 |
| 0.5 | 0 | 0.0533 | 0.0890 | 0.1156 | 0.1124 | 0.1189 | 0.1189 | 0.1253 | 0.1421 | 0.1465 | 0.1482 | 0.1488 |
| 0.6 | 0 | 0.0702 | 0.1317 | 0.1521 | 0.1387 | 0.1443 | 0.1413 | 0.1519 | 0.1690 | 0.1746 | 0.1715 | 0.1669 |
| 0.7 | 0 | 0.0822 | 0.1686 | 0.1709 | 0.1610 | 0.1651 | 0.1652 | 0.1818 | 0.1851 | 0.1827 | 0.1818 | 0.1777 |
| 0.8 | 0 | 0.1079 | 0.1841 | 0.1917 | 0.1839 | 0.1909 | 0.1882 | 0.1958 | 0.1986 | 0.2066 | 0.2028 | 0.1975 |
| 0.9 | 0 | 0.1165 | 0.2312 | 0.2241 | 0.2130 | 0.2210 | 0.2173 | 0.2151 | 0.2200 | 0.2196 | 0.2139 | 0.2116 |
| 1 | 0 | 0.1337 | 0.2568 | 0.2453 | 0.2352 | 0.2477 | 0.2381 | 0.2436 | 0.2322 | 0.2391 | 0.2311 | 0.2281 |

TABLE 2
R_{Up}(t, d)

| | t | | | | | | | | | | | |
|---|---|---|---|---|---|---|---|---|---|---|---|---|
| d | 0 | 0.05 | 0.15 | 0.25 | 0.35 | 0.45 | 0.55 | 0.65 | 0.75 | 0.85 | 0.95 | 1 |
| 0 | 0 | 0 | 0 | 0 | 0 | 0 | 0 | 0 | 0 | 0 | 0 | 0 |
| 0.1 | 0 | 0.0006 | 0.0241 | 0.0257 | 0.0383 | 0.0770 | 0.0245 | 0.0338 | 0.1565 | 0.1376 | 0.1030 | 0.054 |
| 0.2 | 0 | 0.0008 | 0.0320 | 0.0829 | 0.0921 | 0.1357 | 0.0491 | 0.0576 | 0.2209 | 0.2392 | 0.2091 | 0.116 |
| 0.3 | 0 | 0.0011 | 0.0368 | 0.1316 | 0.1831 | 0.1955 | 0.0771 | 0.0982 | 0.3479 | 0.3740 | 0.2861 | 0.162 |
| 0.4 | 0 | 0.0014 | 0.0633 | 0.2496 | 0.3143 | 0.2537 | 0.1166 | 0.1429 | 0.5006 | 0.4902 | 0.4130 | 0.24 |
| 0.5 | 0 | 0.0023 | 0.0774 | 0.3412 | 0.4422 | 0.3016 | 0.1539 | 0.1903 | 0.5502 | 0.6449 | 0.4607 | 0.297 |
| 0.6 | 0 | 0.0020 | 0.1120 | 0.4936 | 0.5382 | 0.3451 | 0.2075 | 0.2423 | 0.6771 | 0.7367 | 0.6053 | 0.393 |
| 0.7 | 0 | 0.0022 | 0.1812 | 0.6964 | 0.6233 | 0.3790 | 0.2419 | 0.3288 | 0.8383 | 0.8358 | 0.6330 | 0.424 |
| 0.8 | 0 | 0.0023 | 0.2569 | 0.8706 | 0.6753 | 0.4277 | 0.2824 | 0.4167 | 0.9068 | 0.8754 | 0.7830 | 0.532 |
| 0.9 | 0 | 0.0027 | 0.3305 | 0.9888 | 0.7399 | 0.4896 | 0.3213 | 0.4463 | 1.0404 | 0.9820 | 0.8205 | 0.586 |
| 1 | 0 | 0.0028 | 0.4009 | 1.1153 | 0.7796 | 0.5238 | 0.3772 | 0.5363 | 1.1867 | 1.0951 | 0.8720 | 0.68 |

TABLE 3
R_{Down}(t, d)

| | t | | | | | | | | | | | |
|---|---|---|---|---|---|---|---|---|---|---|---|---|
| d | 0 | 0.05 | 0.15 | 0.25 | 0.35 | 0.45 | 0.55 | 0.65 | 0.75 | 0.85 | 0.95 | 1 |
| 0 | 0 | 0 | 0 | 0 | 0 | 0 | 0 | 0 | 0 | 0 | 0 | 0 |
| 0.1 | 0 | 0.0024 | 0.0400 | 0.0424 | 0.0393 | 0.0255 | 0.0249 | 0.0229 | 0.0274 | 0.0442 | 0.0925 | 0.2011 |
| 0.2 | 0 | 0.0024 | 0.0369 | 0.0390 | 0.0379 | 0.0309 | 0.0287 | 0.0247 | 0.0350 | 0.0880 | 0.1246 | 0.2080 |
| 0.3 | 0 | 0.0025 | 0.0314 | 0.0358 | 0.0270 | 0.0220 | 0.0204 | 0.0400 | 0.0436 | 0.0528 | 0.0979 | 0.1864 |
| 0.4 | 0 | 0.0027 | 0.0323 | 0.0339 | 0.0258 | 0.0166 | 0.0162 | 0.0336 | 0.0324 | 0.0459 | 0.0883 | 0.1612 |
| 0.5 | 0 | 0.0029 | 0.0293 | 0.0285 | 0.0235 | 0.0177 | 0.0185 | 0.0200 | 0.0147 | 0.0297 | 0.0639 | 0.1428 |
| 0.6 | 0 | 0.0027 | 0.0255 | 0.0262 | 0.0212 | 0.0154 | 0.0139 | 0.0185 | 0.0289 | 0.0351 | 0.1261 | 0.1693 |
| 0.7 | 0 | 0.0031 | 0.0189 | 0.0224 | 0.0181 | 0.0108 | 0.0112 | 0.0166 | 0.0247 | 0.0251 | 0.0520 | 0.1088 |
| 0.8 | 0 | 0.0025 | 0.0131 | 0.0181 | 0.0135 | 0.0166 | 0.0085 | 0.0135 | 0.0189 | 0.0197 | 0.0774 | 0.1265 |
| 0.9 | 0 | 0.0024 | 0.0073 | 0.0139 | 0.0104 | 0.0143 | 0.0046 | 0.0108 | 0.0127 | 0.0143 | 0.0400 | 0.0882 |
| 1 | 0 | 0.0022 | 0.0040 | 0.0085 | 0.0066 | 0.0073 | 0.0027 | 0.0058 | 0.0089 | 0.0080 | 0.0320 | 0.0744 |

### IV. A Constraints Set for Confidence Region:

For a given risk aversion parameter and a standard deviation d, it is possible to find an optimal portfolio h* for the problem (1). Now, we can compute a tradeoff coefficient t corresponding to h* and set up the following upper bound on portfolio risk:

Risk(h)≦Risk(h*)*(1+R_{Up}(t,d)). (13)

In order to set up a lower bound on portfolio's expected return, the problem below should be solved:

$${h}^{′} = Arg {max}_{\{ h ∈ Q ⋀ Risk ( h ) == Risk ( {h}^{*} ) * ( 1 - {R}_{Down} ( t , d ) ) \}} {α}^{T} h . \qquad ( 14 )$$

Using this solution, a constraint can be established:

α^{T}h≧α^{T}h′*(1−δ(t,d)). (15)

### Computation of Sharpe Ratio in Some Embodiments:

In some embodiments, an optimizer is provided that can provide an optimization of a portfolio of assets based on Sharpe Ratio as a measure of goodness. Preferably, the system can provide an ex-ante maximization based on expected return and expected risk. Rather than merely using the Sharpe Ratio in an ex-post manner looking backward, embodiments can provide a forward looking optimization based on the Sharpe Ratio. Thus, in some embodiments of the invention a unique form of portfolio optimization can be provided based on, e.g., the maximization of the Sharpe Ratio.

### I. Definitions and Assumptions:

In some embodiments, the standard objective function is a maximum of a sum of the following terms multiplied by some coefficients over all portfolios h from a set Q (this set is defined by constraints imposed on the portfolio):

α(h)—the expected return of the final portfolio;

Risk(h)—the variance of return of the final portfolio (or of the difference between the final portfolio and a benchmark portfolio) divided by the basis of the portfolio;

TC(h)—the transaction cost of transition of the current portfolio into the final portfolio;

TaxCost(h)—the total tax liability after transition into the final portfolio;

Penalties(h)—the penalties for violation of some soft constraints and for realizing “almost-long-term” gains.

Preferably, in the optimal portfolio selection problem, we look for a portfolio that maximizes expected return with relatively low values of Risk, TC, TaxCost and Penalties. In that regard, we set a positive coefficient before α and negative coefficients before all other terms. We can group all terms but risk into one term, A(h), we can call it “adjusted return.” This term represents a total return after accounting for all extra expenses. We can denote a coefficient before a risk term by −γ, where γ is a risk aversion parameter. This parameter can establish a trade-off between risk and return of a potential investment portfolio.

In some embodiments, an alternative objective function could be the maximization of the reward-to-variability ratio S of a potential investment portfolio hεQ.

$$S ( h ) = \frac{A ( h )}{\sqrt{Risk ( h )}} .$$

This ratio is known as the Sharpe ratio or Sharpe's measure. In this case, Risk is the variance of return of the final portfolio. A variance of return of the difference between the final portfolio and a benchmark portfolio is not used as Risk for the Sharpe ratio. Additionally, while in the standard objective function, the Risk is divided by portfolio basis B, one shouldn't divide Risk by B in the Sharpe ratio.

### II. Finding the Sharpe Ratio in Some Embodiments:

In some embodiments, it is possible to maximize S² instead of S. Accordingly, the square root of the Risk in the denominator is removed.

First, A² is replaced with its piece-wise linear approximation. In that regard, a lower and an upper bounds on A are located, such that a value of A, that maximizes S, lies between these bounds.

### A. Algorithm Find Bounds:

In some embodiments, an algorithm find bounds is used. In some embodiments, the algorithm can include substantially the following:

Find an optimal solution h* for the problem: max _{{h ε Q}} A(h);

Set UpperBound = A(h*);
Set LowerBound = A(h*)/2;
Set S1 = A(h*)/sqrt(Risk(h*));
Set flag = 1;
Find an optimal solution h* for the problem:

max_{{h ε Q, A(h) == LowerBound}}Risk(h);

Set S2 = A(h*)/sqrt(Risk(h*));
If (S2<S1) flag = 0;
while (flag) {

LowerBound /= 2.0;
S1 = S2;
Find an optimal solution h* for the problem:

max_{{h ε Q, A(h) == LowerBound}}Risk(h);

Set S2 = A(h*)/sqrt(Risk(h*));
If (S2<S1) flag = 0;

else UpperBound = LowerBound*2.0;

}

In most cases during the above algorithm, a LP (linear program) is solved three times. This algorithm terminates with values LowerBound and UpperBound for lower and upper bounds on A respectively. A set of links is defined I₁, I₂, . . . , Iₙ to represent A and create a piece-wise linear approximation A2 for the A², where I₁=LowerBound and Iₙ=UpperBound. We set Iᵢ₊₁=Iᵢ(1+b) for every i<n−1, and Iₙ≦Iₙ₋₁(1+b), and the n should be chosen to satisfy these conditions. For a given relative error value (1+e) in approximation of A² by A2, we set

b=2(e+\sqrt{e(e+1)}).

If, as merely one illustrative example, e=0.0002, then error in the approximation of A² is at most 1.0002 and the final error in S is at most 1.0001. In some embodiments, the value of e is a user-selected variable, which can be selected, e.g., via a computer input device.

It is now possible to find the maximum Sharpe ratio S. We set an initial value of S to the value of S1 from the previous algorithm.

### B. Algorithm Find Sharpe Ratio:

In some embodiments, an algorithm find Sharpe Ratio is provided. In some embodiments, the algorithm can include substantially the following:

Set LastS = 0;
while(S − LastS > 0.001) {

Find an optimal solution h* for a problem:

X = max_{{h ε Q}} [A2(h) − S*S*Risk(h)];

Set LastS = S;
Set S = sqrt(S*S + X/Risk(h*))

}

In some embodiments, the algorithm outputs an optimal value of a Sharpe Ratio S and a portfolio h* that achieves this ratio. In some embodiments, to decrease a computation time, optimization is started, in every iteration, from the optimal solution obtained in the previous iteration.

### III. Convergence of the Method in Embodiments:

In the above algorithm “find bounds,” the problem starts with maximum possible value of adjusted return. In some embodiments, this number is decreased by a factor of two at each step of the algorithm. In some embodiments, the algorithm terminates when the best value of a Sharpe Ratio, that corresponds to the current level of the adjusted return, is lower then the Sharpe Ratio at the previous iteration. In most cases, the maximum value of Sharpe Ratio is achieved with adjusted return between the maximum adjusted return and a half of the maximum adjusted return.

In the algorithm “find Sharpe Ratio,” at each iteration, an updated guess of the maximum Sharpe Ratio value S is used. This is denoted by Sᵢ, hᵢ and Xᵢ the values of S, h* and X correspondingly that were obtained in ith iteration of the algorithm. Since Xᵢ is a maximum of the optimization problem in the iteration i for every portfolio h, we have

A²(h)−Sᵢ²Risk(h)≦Xᵢ. (1)

By using an optimal portfolio hᵢ₊₁ from iteration i+1 into inequality (1), we get

$$\frac{{A}^{2} ( {h}_{i + 1} )}{Risk ( {h}_{i + 1} )} \leq {S}_{i}^{2} + \frac{{X}_{i}}{Risk ( {h}_{i + 1} )} . \qquad ( 2 )$$

Now, the iteration i+1 is as follows:

$$\begin{matrix}{A}^{2} ( {h}_{i + 1} ) - {S}_{i + 1}^{2} Risk ( {h}_{i + 1} ) = {X}_{i + 1} , \\ Where & ( 3 ) \\ {S}_{i + 1}^{2} = {S}_{i}^{2} + \frac{{X}_{i}}{Risk ( {h}_{i} )} . & ( 4 )\end{matrix}$$

Now, we substitute (4) into (3) and get:

$$\frac{{A}^{2} ( {h}_{i + 1} )}{Risk ( {h}_{i + 1} )} = {S}_{i}^{2} + \frac{{X}_{i}}{Risk ( {h}_{i} )} + \frac{{X}_{i + 1}}{Risk ( {h}_{i + 1} )} . \qquad ( 5 )$$

Finally, taking (2) and (5) together we get:

$$\frac{{X}_{i}}{Risk ( {h}_{i} )} \leq \frac{{X}_{i} - {X}_{i + 1}}{Risk ( {h}_{i + 1} )} . \qquad ( 6 )$$

From the last inequality, it is possible to conclude the following properties of the algorithm:

For every iteration i of the algorithm, we have Xᵢ ≧ Xᵢ₊₁.

For every iteration i of the algorithm, we have Risk(hᵢ) ≧ Risk(hᵢ₊₁).
If Xᵢ/2 ≦ Xᵢ₊₁, then Risk(h₁) /2 ≧ Risk(hᵢ₊₁).

These properties illustrate that the algorithm converges at an exponential rate to the optimal value of Sharpe Ratio.

### Multi-Portfolio Optimization in Some Embodiments:

In some embodiments of the invention, the optimization system can address situations in which, for example, a portfolio manager manages portfolios for one or more clients, wherein the client(s) have different portfolios of assets. In some embodiments, the system is adapted to be able to rebalance portfolios on a large scale rather than only small scale (such as, e.g., individual scale) rebalancing. For instance, the system can rebalance on a large scale without having each individual have to make certain trades individually. Notably, while individual accounts may differ, they still often may have common assets within their portfolios.

In some embodiments, the system performs optimization on a smaller or individual basis (such as, e.g., on an account-by-account basis) and evaluates which results also satisfy multi-portfolio needs. Thus, certain embodiments can, essentially, optimize individual accounts, subject to an aggregate. Based on this optimization, the system can generate results providing optimized portfolios across multiple accounts—reducing potential transaction costs, reducing the frequency of required trades and/or providing other benefits.

### I. Definitions and Assumptions:

The standard optimization problem in some embodiments involves maximizing a certain objective function Ω(h) over all portfolios h from a constraint set Q that is defined by constraints imposed on the portfolio. In multi-portfolio optimization, there are K portfolios such that for every portfolio hₖ, k=1, . . . , K, there is an objective function Ωₖ(hₖ) and a constraint set Qₖ. In addition, the total portfolio Σ_{k=1,K}hₖ should satisfy a constraint set Q for the total portfolio.

hₖ^{Opt}, k=1, . . . , K, denotes a portfolio that maximizes value of the objective function Ωₖ such that hₖ^{Opt}εQₖ. Many portfolio managers have, e.g., the following multi-portfolio optimization problem: find an optimal set of K portfolios h₁, . . . , h_{K} such that Σ_{k=1,K}hₖεQ and for every portfolio hₖ we have hₖεQₖ and value of Ωₖ(hₖ) is close to the optimal value Ωₖ(hₖ^{Opt}). In some embodiments, two different measures of distance between Ωₖ(hₖ) and Ωₖ(hₖ^{Opt}) may be used:

relative measure: minimize value of

$$\frac{{Ω}_{k} ( {h}_{k}^{Opt} ) - {Ω}_{k} ( {h}_{k} )}{{Ω}_{k} ( {h}_{k}^{Opt} )} ;$$

absolute measure: minimize value of

Ωₖ(hₖ^{Opt})−Ωₖ(hₖ).

In cases where a portfolio manager desires to make value of the objective function of each portfolio to be close to its maximum values in percents, the relative measure can be used. Alternatively, in cases where a portfolio manager desires to make these values to be close in dollars, the absolute measure can be used.

### II. Algorithm for Multi-Portfolio Optimization:

In some embodiments, an algorithm for multi-portfolio optimization can include substantially the following:

In a first step of the algorithm, it is possible to find an optimal portfolio hₖ^{Opt}εQₖ for every k, k=1, . . . , K.

In a second step of the algorithm, it is possible to distinguish between two cases:

relative measure: maximize value of scalar variable x under the following constraints:

$${Ω}_{k} ( {h}_{k} ) \geq {Ω}_{k} ( {h}_{k}^{Opt} ) * x , ∀ k ∈ \{ 1 , … , K \} , \\ {h}_{k} ∈ {Q}_{k} , ∀ k ∈ \{ 1 , … , K \} , \\ {\sum }_{k = 1}^{K} {h}_{k} ∈ Q ;$$

absolute measure: minimize value of scalar variable y under the following constraints:

$${Ω}_{k} ( {h}_{k} ) + y \geq {Ω}_{k} ( {h}_{k}^{Opt} ) , ∀ k ∈ \{ 1 , … , K \} , \\ {h}_{k} ∈ {Q}_{k} , ∀ k ∈ \{ 1 , … , K \} , \\ {\sum }_{k = 1}^{K} {h}_{k} ∈ Q .$$

For the relative measure case, it is assumed that the value of Ωₖ(hₖ^{Opt}) is positive. Where it is negative, the value of the variable x is minimized instead of maximized.

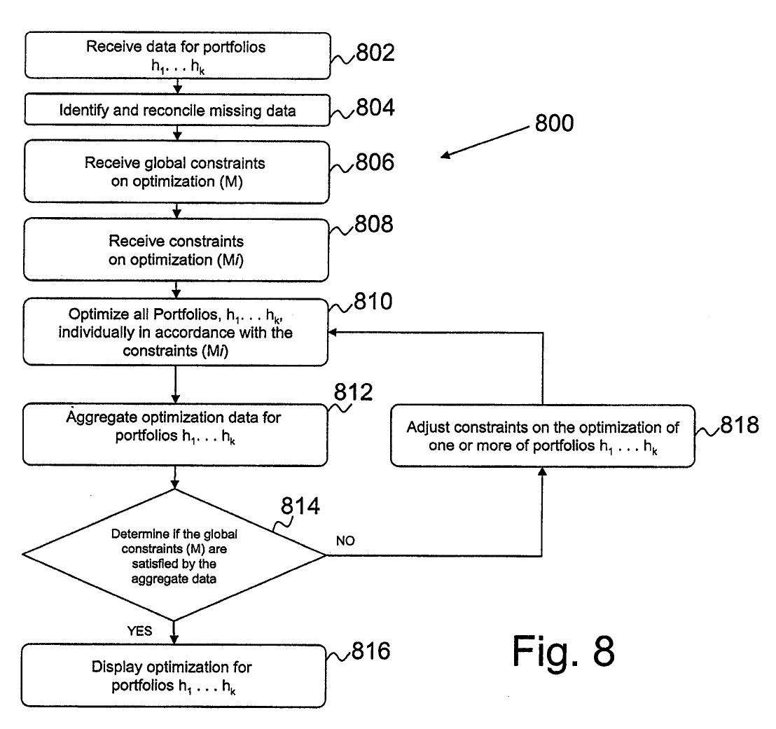

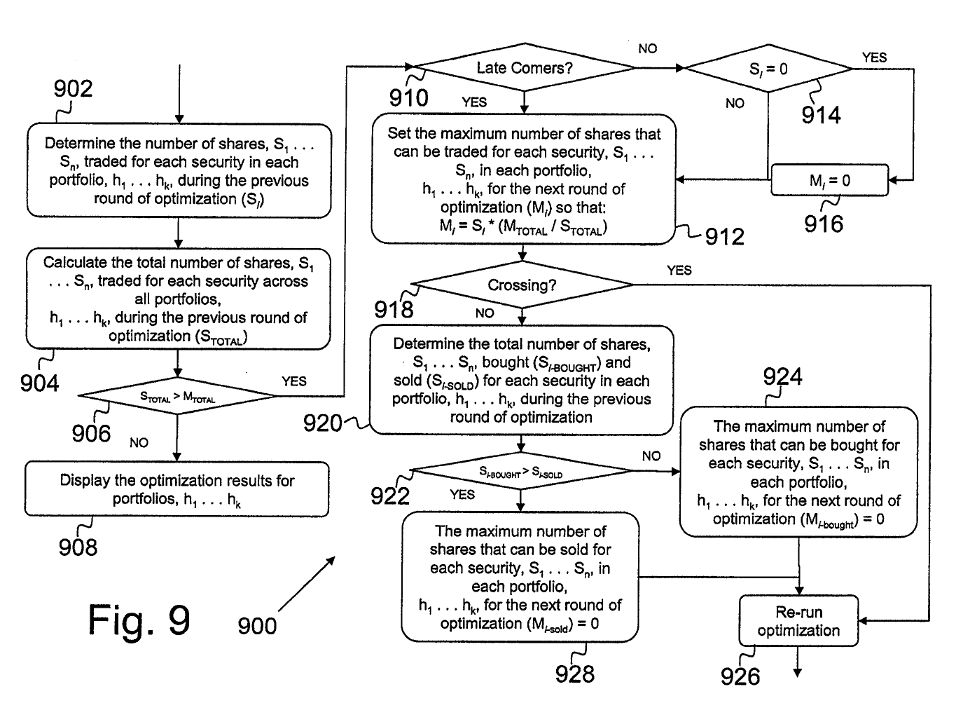

Additionally, the invention as claimed can optimize a plurality of portfolios subject to global constraints. This optimization may take multiple rounds in order to reach an acceptable solution given the applicable constraints. One embodiment of the invention is illustrated in FIG. 8, with further detail shown in FIG. 9.

FIG. 8 is a flow diagram illustrating one example of the method and system of the current invention. In process 800, the system receives data for a plurality of portfolios at step 802. The system then performs a check to ensure that all necessary data is present and correct at step 804. The system then receives global constraints at step 806. These constraints are to be considered in optimizing the total plurality of portfolios. Some global constraints that might be used would relate to, but are not limited to: total assets traded (percentage, number, monetary), total assets sold (percentage, number, monetary), total assets bought (percentage, number, monetary), acceptable risk levels, transaction costs, late corners, and crossing.

Next, at step 808, the system receives parameters to be used in optimizing the individual portfolios. The system then optimizes the portfolios independently using the individual optimization parameters on individual portfolios at step 810. This newly optimized asset data is then aggregated at step 812, and the aggregated optimization asset data is checked to determine if it is within the bounds of the global constraints at step 814. If the aggregate optimized asset data satisfies the global constraints, the optimized asset data for each portfolio is displayed at step 816. However, in the event that the aggregate optimized asset data fails to satisfy the global constraints, the constraints on the individual portfolios are adjusted at step 818 and the optimization is rerun beginning with step 810. This process continues interactively until such time that the aggregate optimized asset data satisfies the global constraints.

The following example illustrates non-limiting aspects of the present which:

Three portfolios (h), each having 3 securities (S) to be traded:

h₁: S₁, S₂, S₃

h₂: S₁, S₂, S₄

h₃: S₁, S₅, S₆

The optimization of these three portfolios is subject to the following global constraints (M_{TOTAL}):

M_{TOTAL-1}: S₁≦100 Shares Traded

M_{TOTAL-2}: S₂≦100 Shares Traded

M_{TOTAL-3}: Total Trade Cost≦$200

The optimization of these three portfolios is subject to the following individual constraints (Mᵢ). For the purposes of explanation and example, the constraints are identified according to the scheme: M_{PORTFOLIO-CONSTRIAINT NUMBER}. While in this example the individual constraints mirror the global constraints, this is only one example of an embodiment. Another embodiment might have individual portfolio constraints that do not mirror the global constraints in either matter, i.e. securities, or amount, i.e. shares. Another embodiment might have individual constraints both mirroring and different from the global constraints, in part or in whole. In this example, the individual constraints are shown below:

M₁₋₁: S₁ ≦ 100 Shares Traded
M₁₋₂: S₂ ≦ 100 Shares Traded
M₁₋₃: Total Trade Cost ≦$200
M₂₋₁: S₁ ≦ 100 Shares Traded
M₂₋₂: S₂ ≦ 100 Shares Traded
M₂₋₃: Total Trade Cost ≦$200
M₃₋₁: S₁ ≦ 100 Shares Traded
M₃₋₂: S₂ ≦ 100 Shares Traded
M₃₋₃: Total Trade Cost ≦$200

If each portfolio were optimized, individually a possible outcome could be, assuming all other aspects of the example are in order:

h₁
S₁ = 100 Shares Traded
S₂ = 100 Shares Traded
S₃ = 100 Shares Traded
Total Trade Cost = $100
h₂
S₁ = 100 Shares Traded
S₂ = 100 Shares Traded
S₄ = 100 Shares Traded
Total Trade Cost = $10
h₃
S₁ = 100 Shares Traded
S₅ = 100 Shares Traded
S₆ = 100 Shares Traded
Total Trade Cost = $10

While these individual portfolio optimizations meet the constraints placed on the individual portfolios, the aggregated asset data must still be checked to determine if the global constraints have been satisfied. The aggregated optimization data is as follows:

300 Shares S₁ Traded
200 Shares S₂ Traded
100 Shares S₃ Traded
100 Shares S₄ Traded
100 Shares S₅ Traded
100 Shares S₆ Traded
Total Trade Cost = $300

Thus, the number of S₁ and S₂ shares that were traded across all of the portfolios exceeded the aggregate number of shares the portfolio manager intended to trade. Further, the cost of the trades across all of the portfolios exceeds the maximum intended trade cost of the portfolios as a whole.

Therefore, where aggregate constraints may be imposed on multi-portfolio optimization, the system can adjust the constraints on the individual portfolios and rerun the optimization.

FIG. 9 is a flow diagram that illustrates an example of how the current invention may adjust the individual portfolio constraints. At step 902, a determination is made of how many of each share was traded in each portfolio during the previous round of optimization (Sᵢ). These individual share amounts are summed in order to determine the aggregate number of shares traded across all of the portfolios (S_{TOTAL}) 904.

This aggregate optimization asset data is checked against the applicable global constraints (S_{TOTAL}>M_{TOTAL}) at step 906. If the constraints are met, the optimized asset data is displayed at step 908. In the event that the global constraints are not satisfied in step 906, the system may adjust the constraints placed on the individual portfolio optimizations in the following manner. A determination if “late comers” are allowed is made at step 910.

Allowing “late comers” would allow securities that were not traded in a particular portfolio during the previous round of optimization to be traded in current round of optimization. If “late comers” are not allowed, the system must check to see if each security was traded during the previous round of optimization at step 914. If the security was not traded during the previous round of optimization the maximum number of shares that can be traded of that security in the next round of optimization (Mᵢ) is set equal to zero at step 916. If the security was traded during the previous round of optimization, the maximum number of shares that can be traded of that security in a particular portfolio during the next round of optimization (Mᵢ) is set equal to the number of shares traded for that security in each portfolio during the previous round of optimization multiplied by the global constraint on the number of shares that can be traded for a security across all the portfolios divided by the aggregate number of shares that were traded for a security across all the portfolios during the previous round of optimization [Sᵢ*(M_{TOTAL}/S_{TOTAL})] at step 912.

Next the system checks to see if “crossing” is permitted at step 918. “Crossing” occurs when an individual stock is both bought and sold across the multiple portfolios being optimized. If “crossing” permitted, than the optimization is rerun with the adjusted constraints at step 926. If “crossing” is not permitted then a determination of the aggregate number of shares of a particular security bought (S_{i-BOUGHT}) and sold (S_{i-SOLD}) across all of the optimized portfolios must be determined at step 920.

It is determined at step 922 whether the aggregate number of shares of a particular security bought (S_{i-BOUGHT}) is greater than the aggregate number of shares of a particular security sold (S_{i-SOLD}). If so, then the maximum number of shares that can be sold for that security during the next round of optimization is set to zero at step 928. If the aggregate number of shares of a particular security bought (S_{i-BOUGHT}) is less than the aggregate number of shares of a particular security sold (S_{i-SOLD}), then the maximum number of shares that can be bought for that security during the next round of optimization is set to zero at step 924. In one embodiment, when a buy or sell side is set to zero to prevent “crossing,” the adjusted constraints to be used during subsequent optimization rounds relate only to the buy or sell side which is not set to zero. Finally, the optimization is rerun (step 926) using the adjusted constraints.

Referring back to the example begun with reference to FIG. 8, in which both the number of S₁ and S₂ shares traded and the cost of the trades exceeded the trader's intended limits, the constraints on the individual portfolios are now adjusted as follows.

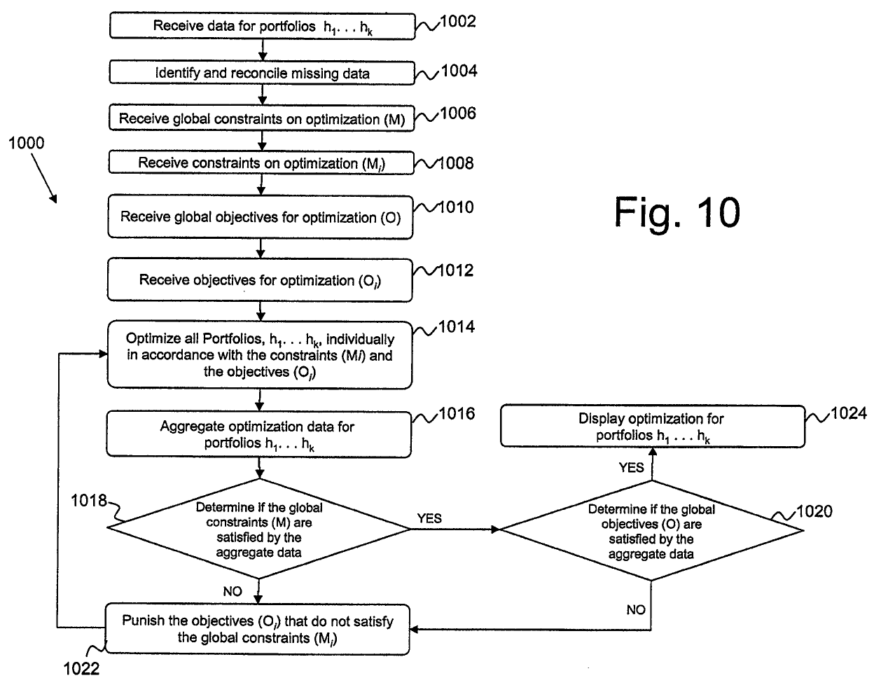

Assuming “late comers” and “crossing” are both permitted the adjustment might be the following. Using the formula from FIG. 10, Mᵢ=Sᵢ*(M_{TOTAL}/S_{TOTAL}), the following calculations yield the maximum number of shares that can be traded of each security in the next round of optimization.

M₁₋₁: S₁≦33 Shares Traded [100*(100/300)]

M₁₋₂: S₂≦50 Shares Traded [100*(100/200)]

M₁₋₃: Total Trade Cost≦$200

M₂₋₁: S₁≦33 Shares Traded [100*(100/300)]

M₂₋₂: S₂≦50 Shares Traded [100*(100/200)]

M₂₋₃: Total Trade Cost≦$200

M₃₋₁: S₁≦33 Shares Traded [100*(100/300)]

M₃₋₂: S₂≦50 Shares Traded [100*(100/200)]

M₃₋₃: Total Trade Cost≦$200

Therefore, the next round of optimization might yield an outcome like the following:

h₁
S₁ = 33 Shares Traded
S₂ = 50 Shares Traded
S₃ = 100 Shares Traded
Total Trade Cost = $61
h₂
S₁ = 33 Shares Traded
S₂ = 50 Shares Traded
S₄ = 100 Shares Traded
Total Trade Cost = $61
h₃
S₁ = 33 Shares Traded
S₅ = 100 Shares Traded
S₆ = 100 Shares Traded
Total Trade Cost = $78

The aggregate data for the current round of optimization satisfies all of the global constraints. The total trade cost was reduced to a lower level which satisfies the global constraint due to the difference in the number of shares traded of each security. The satisfactory aggregate data is shown below:

S₁ = 99 Shares Traded
S₂ = 100 Shares Traded
S₃ = 100 Shares Traded
S₄ = 100 Shares Traded
S₅ = 100 Shares Traded
S₆ = 100 Shares Traded
Total Trade Cost = $200

Therefore, by adjusting the constraints in accordance with the claimed invention the optimization was able to adjust the constraints on individual portfolio optimization in order to satisfy global constraints place on the plurality of portfolios as a whole.

### III. Optimal Solution and Solving Time:

The optimal set of portfolios h₁, . . . , h_{K}, which is computed by the algorithm above, minimizes the value of the maximum relative or absolute distance of the value of the objective function Ωₖ(hₖ) from the value Ωₖ(hₖ^{Opt}), where maximum is taken over all portfolios h₁, . . . , h_{K}. This set also satisfies the constraint on the total portfolio Σ_{k=1,K}hₖ. Therefore, the solution satisfies the properties required by portfolio managers in multi-portfolio optimization.

In some embodiments, the time needed to solve the first step in the algorithm is substantially equal to the time of finding the optimal solution for all portfolios hₖ, k=1, . . . , K. This is to be solved even without additional constraint on the total portfolio. In the second step, one more optimization problem is to be solved. However, this should not take substantially more time than for the solution in the first step. In some embodiments, we can use the fact that the optimal solution we have in the first step is the optimal solution for the problem in the second step if the constrain on the total portfolio is relaxed. Therefore, we can first calculate a dual solution for the relaxed problem. Then, we can use this as an initial feasible solution to solve the problem dual to the problem in the second step of the algorithm. This approach can speed up finding the optimal solution in the second step of the algorithm.

### IV. Objective Based Algorithm for Multi-Portfolio Optimization:

Referring to FIG. 10, according to some embodiments of the present invention, it is possible to reach additional “hidden” optimizations by adjusting the individual optimization objective functions such that the numerical value of the functions is less desirable. This adjusting may also be referred to as “punishing” the individual optimization objective functions.

Multi-portfolio optimization can be formulated as an objective function, which is a linear product of multiple individual portfolio objectives subject to individual portfolio constraints and global constraints. The optimal value of an individual portfolio objective function when individually optimized can be represented as Ω*ᵢ where i=1, . . . n portfolios. The least optimal value of an individual portfolio objective function when optimized with the imposition of global constraints can be represented as Ωᵢ^{start} where i=1, . . . n portfolios. Therefore, an individual portfolio objective optimization will fall in the range between Ω*ᵢ and Ωᵢ^{start}. This range can be represented as Δ̅ᵢ. If Ω*ᵢ=Ωᵢ^{start}, then the optimal solution is feasible (that is it does not violate global constraints).

Using these terms, a new slack variable represented as ΔΩᵢ, can be defined by the inequality abs(Ω*ᵢ−Ωᵢ(xᵢ))/ Δ̅ᵢ−ΔΩᵢ≦0. Slack variables measure the deviation of each portfolio from its optimal value as a fraction of its range. This definition guarantees that the slack variable will fall in the range of 0 to 1, where 0 is the optimal value and 1 is merely a feasible value. Slack variables are not dependant on the particular objective desired during optimization.

If individual portfolios that are part of a multi-portfolio optimization have different types of objectives (for example risk, tracking error, return, etc . . . ), over-trading or under-trading of some individual portfolios can result. This situation is often precipitated by size differences in multiple-portfolios that are being optimized together. In this situation, it may be necessary to properly scale or weight the objectives of the individual portfolios such that all portfolios will be traded fairly.

FIG. 10 is a flow diagram which illustrates multi-portfolio optimization using individual portfolio objective “punishing” in order to satisfy global constraints and best meet global objectives. In process 1000, data is received for a plurality of portfolios at step 1002. A check is performed to ensure that all necessary data is present and correct at step 1004. Global constraints are received at step 1003.

Global constraints are to be considered in optimizing the total plurality of portfolios. Some global constraints that can be used would relate to, but are not limited to: total assets traded (percentage, number, monetary), total assets sold (percentage, number, monetary), ACE costs, total assets bought (percentage, number, monetary), acceptable risk levels, transaction costs, late corners, and crossing.

Next, at step 1008, constraints can be received to be used in optimizing the individual portfolios. Global objectives for optimization are received at step 1010.

Global objectives are to be considered in optimizing the total plurality of portfolios and allow managers to apply greater overarching management strategies to investment portfolios. Some global objectives that can be used would relate to, but are not limited to: risk, return, minimization/maximization of the sum of the individual portfolio deviations, or minimization/maximization/equalization of individual portfolio deviation. Individual portfolio deviation may be represented as a slack variable.

Next, at step 1012, individual portfolio objectives to be used in optimizing the individual portfolios are received. These objectives might relate to risk or return.

The portfolios are optimized independently using the constraints and objectives on individual portfolios at step 1014. This newly optimized asset data is then aggregated at step 1016, and the aggregated optimization asset data is checked to determine if it is within the bounds of the global constraints at step 1018. If the aggregate optimized asset data satisfies the global constraints, a determination is made at step 1020 to check if the solution best meets the global objectives. If the solution meets the global objectives, the optimization solutions for the portfolios are displayed at step 1024.

In the event that the aggregate optimized asset data either fails to satisfy the global constraints or fails to meet the global objectives, the individual objective functions are “punished” at step 1022 and the optimization is rerun beginning with step 1014. Objectives are punished in an effort to satisfy the global constraints on the optimization. The technique of Lagrangian Relaxation can be used. The amount that an objective function is “punished” is determined using Lagrangian Dual Problems, which is part of Lagrangian Relaxation method—a well known technique in the field of optimization.

While it is not necessary that a global objective be applied to the multi-portfolio optimization, this option provides for an additional level of control which has not historically been available in multi-portfolio optimization solutions. Two examples of global objectives are: the minimization of the sum of the individual portfolio deviations, and the minimization of the worst individual portfolio deviation. These examples discussed in further detail below.

### Fairness Between Portfolios of Disproportionate Sizes

When optimizing objectives and constraints across multiple portfolios, unintended consequences can occur when portfolios of disproportionate sizes are optimized together, because all of the individual accounts of the multiple portfolios are linked by the cumulative number of shares to be traded. Specifically, if two or more portfolios are of different sizes, and have a common asset to be traded, then the larger portfolio will in some cases adversely affect the trading of the smaller portfolio(s).

For example, two portfolios, A and B, when optimized individually have shares of IBM to BUY. Portfolio A is ten times larger than portfolio B, and while portfolio A needs to BUY 100,000 shares, portfolio B needs only to BUY 10,000 shares. However, portfolio A's BUY of 100,000 shares will drive up the price of IBM stock and adversely affect portfolio B's smaller BUY of 10,000 shares.

Additionally, to establish fairness, the invention, in some embodiments, allows for transaction costs to be split between portfolios in situations were crossing is allowed. For example, a large portfolio trading a large number of shares incurs less transaction cost per share than a small portfolio trading a small number of shares. Thus, in situations were crossing is allowed and a large portfolio has benefited from crossing, the transaction costs associated with the trading of the small portfolio can be redistributed, wholly or in part, to the larger portfolio in an effort to prevent adversely affecting the smaller portfolio.

Thus, according to an embodiment of the present invention, the optimization systems and methods may include features for ensuring fairness when portfolios of disproportionate sizes are optimized together, to reduce unintended consequences resulting from the size difference.

An aspect of fairness can be achieved, while at the same time reducing trading costs, by optimizing an amount of cross trading between portfolios and/or reduction or elimination of trades by smaller portfolios when larger portfolios are trading significant volumes of the same assets. The trading cost per share of each security is set to depend upon the total trading volume of the security traded by all managers of the relevant portfolios. In modeling trading costs, algorithms for the distribution of the net volume of trading among multiple portfolios being optimized take into consideration the total wealth of each portfolio and, therefore, the trading cost per share is less expensive for the larger portfolios. One embodiment of this invention can be described according to the following model.

Part of the model of individual portfolio i related to the trading cost can be presented as:

wⁱ(a)−bⁱ(a)+sⁱ(a)=hⁱ(a),

bⁱ(a)≧b_{cost}ⁱ(a), sⁱ(a)≧s_{cost}ⁱ(a),

vⁱ(a)=b_{cost}ⁱ(a)+s_{cost}ⁱ(a),

where wi(a)—is the allocation of asset a of the portfolio i, bi(a), si(a)—buy and sell volumes, respectively (as a fraction of portfolio i wealth), of asset a, hi(a)—initial holdings of asset a of the portfolio. a—is an assets universe and I—is the number of individual portfolios.

When crossing is allowed, some of the multiple portfolios being optimized portfolios buy securities from other portfolios. This type of transaction is considered to be “free” (i.e., no additional transaction costs). Only the net balance of non-crossed shares must be bought or sold on the open market. Therefore, in general, each portfolio has transaction expenses only for external buying and selling of securities (volume): b_{cost}ⁱ(a)⁻, s_{cost}ⁱ(a) and vⁱ(a).

The total net volume imbalance for all portfolios can be represented by the equality:

$${\sum }_{i = 1}^{I} {v}^{i} ( a ) = \vert {\sum }_{i = 1}^{I} {b}^{i} ( a ) - {\sum }_{i = 1}^{I} {s}^{i} ( a ) \vert .$$

This equality can also be rewritten in the linear form with the following two inequalities:

$${\sum }_{i = 1}^{I} {v}^{i} ( a ) \geq {\sum }_{i = 1}^{I} {b}^{i} ( a ) - {\sum }_{i = 1}^{I} {s}^{i} ( a ) , \\ and$$

$${\sum }_{i = 1}^{I} {v}^{i} ( a ) \geq {\sum }_{i = 1}^{I} {s}^{i} ( a ) - {\sum }_{i = 1}^{I} {b}^{i} ( a ) .$$

The transaction cost per share depends on the total net volume of trading, v(a). The transaction cost per share can be found using the following:

$${t}_{cost}^{i} ( a ) = φ ( v ( a ) ) * {v}^{i} ( a ) , ∀ i = 1 , … , I , a ∈ A , \\ where$$

$$v ( a ) = {\sum }_{i = 1}^{I} {v}^{i} ( a ) .$$

Based on this model, the trading cost allocation per asset across portfolios depends on the total trading volume of the asset, the wealth of the portfolio, portfolio objective and portfolio constraints.

Thus, transaction costs that are shared across disproportionately sized portfolios can be assigned to the larger of the portfolios because the cost of the trades for the large portfolio is less expensive, on a relative basis, than the cost of the trades for the small portfolio. Any other preferences can be imposed by introduction of the trading cost utility functions to the model.

In cases where crossing is not a “free” transaction, the model can be modified as:

t_{cost}ⁱ(a)=φ(v(a))*vⁱ(a)+t_{cross}(bⁱ(a)−b_{cost}ⁱ(a)+sⁱ(a)−s_{cost}ⁱ(a)) ∀i=1, . . . , I, aεA,

where t_{cross} is the transaction cost per trade for the crossed trades. However, when crossing is not allowed and multiple disproportionately sized portfolios are trading the same asset in the same direction, it may be best to reduce or completely eliminate the trades for the smaller portfolios due to the increased transaction cost driven by the trades of the larger portfolios.

Take an example having 2 disproportionately sized portfolios, which have the following characteristics:

| Portfolio 1 | Portfolio 2 |
|---|---|
| Portfolio Wealth: $500,000 | Portfolio Wealth: $5,000,000 |
| Portfolio Objective: | Portfolio Objective: |
| Minimize Tracking Error | Minimize Tracking Error |
| Portfolio Constraint: | Portfolio Constraint: |
| Return >= 0.015 | Return >= 0.022 |

A comparison of individual optimization and multi-portfolio optimization without crossing and taking into account fairness would look as follows:

| | Individual Optimization | | Multi-Portfolio Optimization | |
|---|---|---|---|---|
| | Portfolio 1 | Portfolio 2 | Portfolio 1 | Portfolio 2 |
| | transaction | transaction | transaction | transaction |
| Asset | (in shares) | (in shares) | (in shares) | (in shares) |
| APC | 13 | 863 | 0 | 863 |
| BBY | 19 | 792 | 0 | 792 |
| BIIB | 16 | 763 | 0 | 763 |

The individual optimization of each portfolio requires the trading of assets APC, BBY, and BIIB. However, the individual optimization does not take into account the fact that the smaller portfolio 1 will face by the same price impact as the larger portfolio 2, even though portfolio 1's volume is ten times smaller than portfolio 2.

The multi-portfolio optimization recognizes the price impact that will be felt by portfolio 1, and finds a different allocation that does not require trading in APC, BBY, and BIIB for portfolio 1. While the different allocation leads to a slightly higher tracking error, the corresponding utility loss is more than offset by a reduction in the trading costs, as shown in the following table.

| | | | | | Realized |
|---|---|---|---|---|---|
| Optimization | | | Total | Tracking | Trading |
| Method | Portfolio | Return | Risk | Error | Cost |
| Individual | 1 | 0.015 | 0.02258 | 0.01817 | $340.00 |
| Multi- | 1 | 0.015 | 0.02276 | 0.01838 | $109.00 |
| Portfolio | | | | | |
| Individual | 2 | 0.022 | 0.0510 | 0.04918 | $5900.00 |
| Multi- | 2 | 0.022 | 0.0511 | 0.04922 | $5500.00 |
| Portfolio | | | | | |

### Minimization of the Sum of the Individual Portfolio Deviation—Method A

The multi-portfolio global objective for the minimization of the sum of the individual portfolio deviation is used to minimize the collective ΔΩᵢ of the portfolios. This means that the sum of ΔΩᵢ (deviation of each portfolio from its optimal value as a fraction between 0 and 1) will be minimized to the detriment of any other individual objective. Minimizing the deviation of each individual portfolio from its optimal value assures that larger portfolios are not given preference over smaller portfolios due to disproportionate trade volumes.

The multi-portfolio global objective for the minimization of the sum of the individual portfolio deviation can be presented mathematically, as follows:

$$\begin{matrix}E . 1 & {F}^{*} = {min}_{xi , i = 1 , 2 ,} ( {\sum }_{i = 1}^{n} {ΔΩ}_{i} ) \\ E . 2 & abs ( {Ω}_{i}^{*} - {Ω}_{i} ( {x}_{i} ) ) / {Δ}_{i} {ΔΩ}_{i} \\ E . 3 & { \sum }_{i = 1}^{n} ϕ ( {x}_{i} ) \leq {V}_{0} ,\end{matrix}$$

E. 4xᵢεXᵢ, where
Xᵢ—set of constraints on allocations for the individual portfolio i.
xᵢ—vector of allocation for the individual portfolio i.
Inequality E. 3 presents the global constraints across all portfolios (total number of shares traded or trading cost).

Multiple portfolios that are trying to meet this global objective will be, in part, optimized individually and checked for global constraint adherence. The best solution to this objective would be that each individual portfolio's optimization solution, which can be expressed as Ω*ᵢ=Ωᵢ^{start}, also be a feasible optimization solution under any global constraints. However, in situations where Ω*ᵢ=Ωᵢ^{start} does not occur, the individual objectives can be “punished” in order to minimize the sum deviation across all portfolios.

### Minimization of the Worst Individual Portfolio Deviation—Method B

The multi-portfolio global objective for the minimization of the worst individual portfolio deviation is used to minimize the worst individual ΔΩᵢ of the portfolios. This means that the ΔΩᵢ (deviation of each portfolio from its optimal value as a fraction between 0 and 1) of the portfolio having the worst deviation will be improved upon to the detriment of any other individual objective. This is a safeguard against treating large and small portfolios differently, in that if a small portfolio has the worst deviation the large portfolio's deviation will be harmed in an effort to improve the small portfolio's deviation. In some cases, this global objective will result in a solution where each portfolio has an equivalent ΔΩᵢ.

The multi-portfolio global objective for the minimization of the worst individual portfolio deviation (F*) can be presented mathematically, as follows:

$$\begin{matrix}E . 5 & {F}^{*} = min ΔΩ \\ E . 6 & {ΔΩ}_{i} \leq ΔΩ , ∀ i = 1 , … , n \\ E . 7 & abs ( {Ω}_{i}^{*} - {Ω}_{i} ( {x}_{i} ) ) / {Δ}_{i} \leq {ΔΩ}_{i} , ∀ i = 1 , … , n \\ E . 8 & { \sum }_{i = 1}^{n} ϕ ( {x}_{i} ) \leq {V}_{0} , ( {v}_{i} = ϕ ( {x}_{i} ) ) \\ E . 9 & {x}_{i} ∈ {X}_{i} , ∀ i = 1 , … , n\end{matrix}$$

For multi-portfolio optimization using objectives, the values of Ω₁^{start} and Ω₂^{start} can be obtained by solving the problem: E. 6

$$min {\sum }_{i = 1}^{n} ϕ ( {x}_{i} ) ,$$

subject to E. and E. E. 6 finds the minimal number of shares that must be traded to satisfy both portfolios requirements.

Multiple portfolios that are trying to meet this global objective will be, in part, optimized individually and checked for global constraint adherence. The best solution to this objective would be that each individual portfolio's optimization solution, which can be expressed as Ω*ᵢ=Ωᵢ^{start}, also be a feasible optimization solution under any global constraints. However, in situations where Ω*ᵢ=Qᵢ^{start} does not occur, the next best solution would be a solution where each portfolios ΔΩᵢ is equal. In order to arrive at this solution, the individual objectives can be “punished” in order to minimize of the worst individual portfolio deviation.

Examples of Multi-Portfolio Implementation with Global Objectives

The proposed approach is now demonstrated in the following two examples. In each example, two long-only portfolios (n=2) with a “universe” of S&P 500 are optimized. The data that is used in this example has been taken from the 31 Dec. 2006 ITG-daily risk model files: specific risk values are alpha and the closing price.

### Example 1

In the first example, two portfolios have cash allocations, and in the second example these portfolios have been rebalanced with different requirements.

In the first example, the pertinent information is:

| Portfolio 1 | Portfolio 2 |
|---|---|
| Objective: Ω₁ Minimize the tracking | Objective: Ω₂ maximize alpha |
| Error with first 100 stocks (in A-Z | SP 500 universe |
| order) from SP500 universe | |
| Individual Constraint: alpha >= 1.5% | Individual Constraint: |
| | Tracking error <= 100 b.p. |
| Initial Holding: 5000K$ Cash | Initial Holding: 5000K$ Cash |

Total number of shares for both portfolio is globally constrained by: 200000 shares

Portfolios 1 and 2 are bounded by the total trading volume of 200,000 shares. In order to calculate the range Δ̅ᵢ both portfolios have been optimized individually and values Ω₁*, Ω₂* have been obtained. The values of Ω₁^{start}, Ω₂^{start} were obtained by solving the problem E.10. The results of these calculations are as follows:

| | | | | | | Number of | % of shares |
|---|---|---|---|---|---|---|---|
| | | | | | Tracking | shares | traded for each |
| | Ω^{opt} | Ω^{start} | Δ̅ | Alpha | Error | traded | portfolio |
| Portfolio 1 | 0.00111416 | 0.0364872 | 0.03537305 | 1.5% | 3.3% | 145907 | 48% |
| Portfolio 2 | 0.01298149 | 0.00096375 | 0.01201774 | 1.29% | 1% | 158291 | 52% |

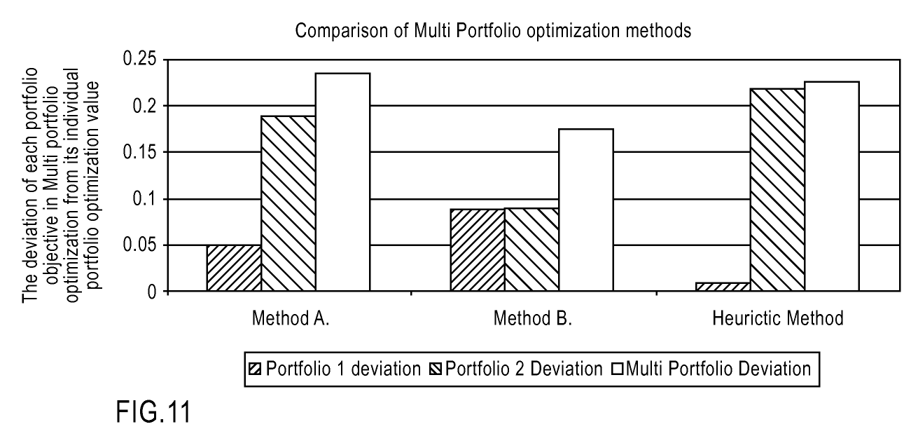

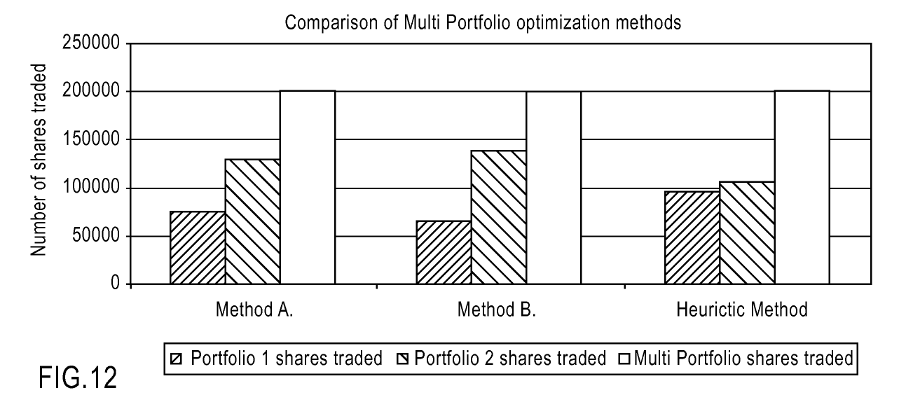

A graphical representation of the multi-portfolio optimization results of these portfolios under Methods A and B and a heuristic approach are illustrated in FIGS. 11 and 12. As shown in FIG. 11, the heuristic method highly prioritizes the Portfolio 1 over Portfolio 2, and thus Portfolio 1 is almost optimized to its individual optimal value. However, it is also shown that Portfolio 2 is more than 20% away from the solution of the unconstrained problem. Comparing this result to the results of Methods A and B, it can be seen that by using global objectives, a more controlled method of multi-portfolio optimization can be implemented. FIG. 12 illustrates that while the optimizations are different, the total number of share traded in the portfolios still adheres to the global constraint of 200,000 shares. The data used in assembling FIGS. 11 and 12 can be found in Tables 4, 5, 6, and 7 below.

TABLE 4

| | Multi Portfolio Optimization | | | | |
|---|---|---|---|---|---|
| | Method A. | | | | |
| | | | | | Number of |
| | | | | Tracking | shares |
| | Ω(ν) | ΔΩ | Alpha | Error | traded |
| Portfolio 1 | 0.0026 | 0.042 | 1.5% | 5% | 126515 |
| Portfolio 2 | 0.011 | 0.169 | 1.1% | 1% | 73485 |
| Total | | 0.201 | | | 200000 |

TABLE 5

| | Multi Portfolio Optimization | | | | |
|---|---|---|---|---|---|
| | Method B. | | | | |
| | | | | | Number of |
| | | | | Tracking | shares |
| | Ω(ν) | ΔΩ | Alpha | Error | traded |
| Portfolio 1 | 0.0042 | 0.088 | 1.5% | 6.5% | 62913 |
| Portfolio 2 | 0.012 | 0.088 | 1.2% | 1% | 137086 |
| Total | | 0.176 | | | 199999 |

TABLE 6

| | Heuristic Method. | | | | |
|---|---|---|---|---|---|
| | | | | | Number |
| | | | | Tracking | of shares |
| | Ω(ν) | ΔΩ | Alpha | Error | traded |
| Portfolio 1 | 0.00145 | 0.00956 | 1.5% | 3.8% | 96000 |
| Portfolio 2 | 0.0104 | 0.218 | 1.04% | 1% | 104000 |
| Total | | 0.2276 | | | 200000 |

TABLE 7

| | | | Number of |
|---|---|---|---|
| | | Number of | shares |
| | | shares traded | calculated by |
| | % of shares | for individual | heuristic |
| | traded | portfolios | method |
| Problem1 | 48% | 145907 | 96000 |
| Problem2 | 52% | 158290 | 104000 |
| Total | | 304197 | 200000 |

### Example 2

Example 2 is a more complex scenario involving global constraints, individual constraints, global objectives, and individual objectives.

In the first example, the pertinent information is:

| Portfolio 1 | Portfolio 2 |
|---|---|
| Objective: Ω₁ Minimize the tracking | Objective: Ω₂ maximize alpha |
| Error with the last 250 stocks (in | SP 500 universe |
| A-Z order) from SP500 universe | |
| Constraints: alpha >= 2% | Constraints: Tracking error <= |
| | 150 b.p. The benchmark has been |
| | altered so, the current allocation |
| | has a tracking error >150 b.p. |
| Initial Holding: The allocation | Initial Holding: The allocation |
| calculated by the method B. | calculated by the method B |

Total trading cost is globally constrained by: A total trading cost of $40000.00; Internal cross transaction costs $1 per $1000 transaction and $4 per $1000 transaction on the open market.

Portfolios 1 and 2 are bounded by the total trading cost of $40,000.00. In order to calculate the range Δ̅ᵢ both portfolios have been optimized individually and values Ω*₁, Ω*₂ have been obtained. The values of Ω^{start}₁, Ω^{start}₂ were obtained by solving the problem E.10. The results of these calculations are as follows:

| | | | | | | Trading cost of |
|---|---|---|---|---|---|---|
| | | | | | Tracking | rebalancing |
| | Ω^{opt} | Ω^{start} | Δ̅ | Alpha | Error | individual portfolios |
| Portfolio 1 | 0.00320859 | 0.0890978 | 0.08588922 | 2.0% | 5.6% | $39998.00 |
| Portfolio 2 | 0.01537279 | 0.0119339 | 0.00343892 | 1.54% | 1.49% | $14243.00 |
| | | | | | | $54241.00 |

The results of the individual optimization of the portfolios do not satisfy the global constraint. Specifically, the global constraint limiting the total trading cost to $40,000.00 has not been satisfied. Therefore, the individual objectives will be “punished.”

Further, this example takes into account the possibility that crossing can be a constraint that impacts the total trading cost during portfolio optimization. Specifically, in this example the trading cost is more expensive if crossing is not allowed. Parenthesis around a number in a trading cost column denotes that crossing the increased cost that would occur if crossing were not allowed.

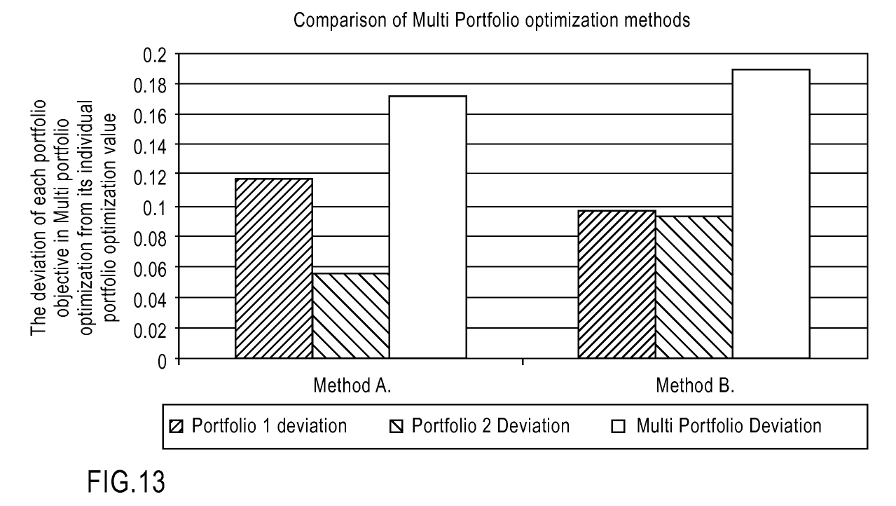

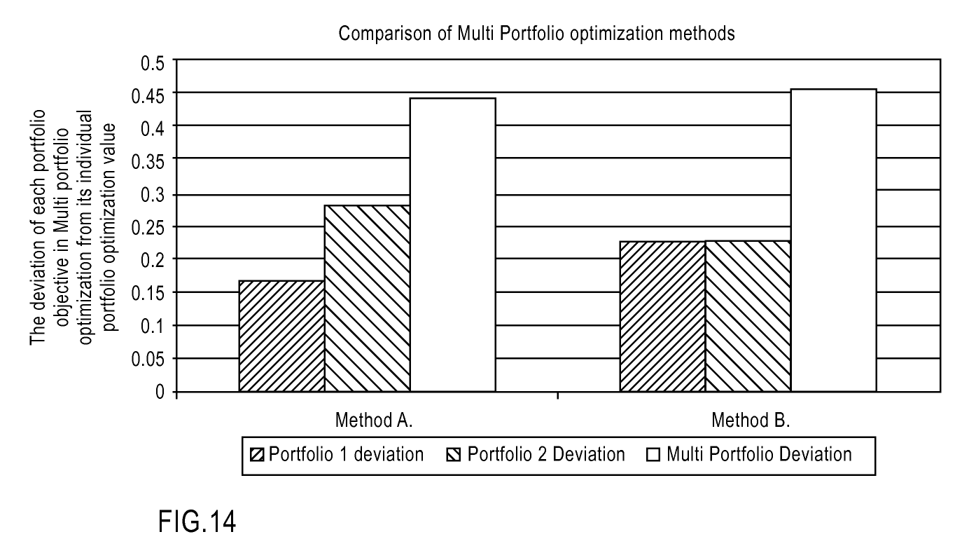

FIG. 13 illustrates the deviations of the portfolios after optimization using Methods A and B in an environment where crossing is allowed. FIG. 14 illustrates the deviations of the portfolios after optimization using Methods A and B in an environment where crossing is not allowed. It is observed that the deviations are greater when crossing is not allowed. This is due, at least in part, to the increased cost of non-crossing trades, which subsequently reduced number of trades that can be made in the portfolios before exceeding the global trade cost constraint.

The data used to create FIG. 13 is found in tables 8 and 9, and the data used to create FIG. 14 is found in tables 10 and 11.

TABLE 8

| | Multi Portfolio Optimization | | | | |
|---|---|---|---|---|---|
| | Method A. | | | | |
| | | | | Tracking | |
| | Ω(ν) | ΔΩ | Alpha | Error | Trading cost |
| Portfolio 1 | 0.0133 | 0.117 | 2.0% | 11.5% | ($37059) |
| Portfolio 2 | 0.0152 | 0.055 | 1.52% | 1.5% | ($12887) |
| Total | | 0.172 | | | $40000 |

TABLE 9

| | Multi Portfolio Optimization | | | | |
|---|---|---|---|---|---|
| | Method B. | | | | |
| | | | | Tracking | |
| | Ω(ν) | ΔΩ | Alpha | Error | Trading cost |
| Portfolio 1 | 0.01156 | 0.097 | 2.0% | 10.7% | ($37324) |
| Portfolio 2 | 0.01505 | 0.093 | 1.5% | 1.5% | ($11840) |
| Total | | 0.176 | | | $40000 |

TABLE 10

| | Multi Portfolio Optimization | | | | |
|---|---|---|---|---|---|
| | Method A. | | | | |
| | | | | Tracking | Transaction |
| | Ω(ν) | ΔΩ | Alpha | Error | cost |
| Portfolio 1 | 0.0176 | 0.164 | 2.0% | 13.2% | $33580 |
| Portfolio 2 | 0.0144 | 0.28 | 1.44% | 1.49% | $6420 |
| Total | | 0.444 | | | $40000 |

TABLE 11

| | Multi Portfolio Optimization | | | | |
|---|---|---|---|---|---|
| | Method B. | | | | |
| | | | | Tracking | Transaction |
| | Ω(ν) | ΔΩ | Alpha | Error | cost |
| Portfolio 1 | 0.023 | 0.226 | 2.0% | 15.2% | $32765 |
| Portfolio 2 | 0.015 | 0.226 | 1.46% | 1.49% | $7235 |
| Total | | 0.453 | | | $40000 |

While illustrative embodiments of the invention have been described herein, the present invention is not limited to the various embodiments described herein, but includes any and all embodiments having modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited.

We claim:

1. A method for optimizing a plurality of portfolios, each portfolio including one or more shares of one or more tradable assets, said method comprising the steps of:
a) receiving asset data defining a plurality of said portfolios;
b) receiving one or more individual portfolio optimization decision variables corresponding to one or more of said plurality of portfolios;
c) receiving one or more global optimization decision variables;
d) for each portfolio of said plurality of portfolios, optimizing said asset data based on a corresponding one or more of said individual optimization decision variables;
e) aggregating said optimized asset data to create aggregate optimized asset data;
f) determining if said aggregate optimized asset data satisfies said one or more global optimization decision variables; and
g) only if said one or more global optimization decision variables is satisfied in step f, outputting said optimized asset data.

2. The method as recited in claim 1, wherein in step b, the individual portfolio optimization decision variables include:
one or more individual optimization constraints and one or more individual optimization objective functions.

3. The method of claim 2, wherein in step c, the global portfolio optimization decision variables include:
one or more global optimization constraints and one or more global optimization objective functions.

4. The method of claim 3, further comprising a step of:
h) if said one or more of said global optimization constraints is not satisfied, adjusting each of said one or more optimization individual optimization objective functions based on each said optimized asset data and said aggregate optimization asset data.

5. The method of claim 4, further comprising a step of:
i) re-optimizing said asset data based on said adjusted decision variables.

6. The method of claim 4, wherein step h adjusts said one or more individual optimization objective functions using Lagrangian Relaxation and Dual Problem Techniques.

7. The method of claim 3, further comprising the step of:
if said one or more global optimization constraints are satisfied, determining if said one or more global optimization objective functions function have been satisfied.

8. The method of claim 7, further comprising the step of:
if said one or more global optimization objective functions have not been satisfied, adjusting said one or more individual optimization objective functions based on each said optimized portfolio data and said aggregate optimization asset data.

9. The method of claim 1, wherein the step a further comprises:
receiving at least one of a name of an asset, a symbol of an asset, a market price of an asset, an average price at which an asset was purchased, a number of shares of an asset in one of said plurality of portfolios, and a number of shares of an asset in a plurality of portfolios.

10. The method of claim 2, wherein the step of receiving one or more individual optimization constraints further comprises a step of receiving at least one constraint defining a maximum number of shares that can be traded for said plurality of portfolios, whether “late comers” are allowed, whether “crossing” is allowed, whether “fairness” is a consideration, or a total maximum transaction cost for all portfolios, a maximum level of risk allowed.

11. The method of claim 2, wherein the step of receiving one or more individual optimization objective functions further comprises a step of receiving at least one objective related to at least one of risk, return, or trading cost.

12. The method of claim 3, wherein said one or more global objectives include at least one of minimization of the sum of the individual portfolio deviations, or minimization of the worst of the individual portfolio deviations.

13. A computer-readable storage medium having computer executable program code stored therein for optimizing a plurality of portfolios by performing the following operations:
a) receiving asset data defining a plurality of said portfolios;
b) receiving one or more individual portfolio optimization decision variables corresponding to one or more of said plurality of portfolios;
c) receiving one or more global optimization decision variables;
d) for each portfolio of said plurality of portfolios, optimizing said asset data based on a corresponding one or more of said individual optimization decision variables;
e) aggregating said optimized asset data to create aggregate optimized asset data;
f) determining if said aggregate optimized asset data satisfies said one or more global optimization decision variables; and
g) only if said one or more global optimization decision variables is satisfied in step f, outputting said optimized asset data.

14. The computer-readable storage medium as recited in claim 13, wherein in operation b, the individual portfolio optimization decision variables include:
one or more individual optimization constraints and one or more individual optimization objective functions.

15. The computer-readable storage medium of claim 14, wherein in operation c, the global portfolio optimization decision variables include:
one or more global optimization constraints and one or more global optimization objective functions.

16. The computer-readable storage medium of claim 15, having further instructions stored thereon for performing the operation:
h) if said one or more of said global optimization constraints is not satisfied, adjusting each of said one or more optimization individual optimization objective functions based on each said optimized asset data and said aggregate optimization asset data.

17. The computer-readable storage medium of claim 16, having further instructions stored thereon for performing the operation:
i) re-optimizing said asset data based on said adjusted decision variables.

18. The computer-readable storage medium of claim 16, wherein operation h adjusts said one or more individual optimization objective functions using Lagrangian Relaxation and Dual Problem Techniques.

19. The computer-readable storage medium of claim 15, having further instructions stored thereon for performing the operation:
if said one or more global optimization constraints are satisfied, determining if said one or more global optimization objective functions function have been satisfied.

20. The computer-readable storage medium of claim 19, having further instructions stored thereon for performing the operation:
if said one or more global optimization objective functions have not been satisfied, adjusting said one or more individual optimization objective functions based on each said optimized portfolio data and said aggregate optimization asset data.

21. The computer-readable storage medium of claim 13, wherein the operation a further comprises:
receiving at least one of a name of an asset, a symbol of an asset, a market price of an asset, an average price at which an asset was purchased, a number of shares of an asset in one of said plurality of portfolios, and a number of shares of an asset in a plurality of portfolios.

22. The computer-readable storage medium of claim 14, wherein the operation a of receiving one or more individual optimization constraints further comprises a step of receiving at least one constraint defining a maximum number of shares that can be traded for said plurality of portfolios, whether “late comers” are allowed, whether “crossing” is allowed, whether “fairness” is a consideration, or a total maximum transaction cost for all portfolios, a maximum level of risk allowed.

23. The computer-readable storage medium of claim 14, wherein the operation of receiving one or more individual optimization objective functions further comprises a step of receiving at least one objective related to at least one of risk, return, or trading cost.

24. The computer-readable storage medium of claim 15, wherein said one or more global objectives include at least one of minimization of the sum of the individual portfolio deviations, or minimization of the worst of the individual portfolio deviations.

25. A system for performing the optimization of a plurality of portfolios of assets, comprising:
a client interface configured to receive asset data defining a plurality of said portfolios, to receive one or more individual portfolio optimization decision variables corresponding to one or more of said plurality of portfolios, to receive one or more global optimization decision variables, to optimize each portfolio of said plurality of portfolios using said asset data and a corresponding one or more of said individual optimization decision variables, to aggregate said optimized asset data to create aggregate optimized asset data; to determine if said aggregate optimized asset data satisfies said one or more global optimization decision variables; and only if said one or more global optimization decision variables is satisfied, to output said optimized asset data.

26. The system as recited in claim 25, wherein the received individual portfolio optimization decision variables include one or more individual optimization constraints and one or more individual optimization objective functions.

27. The system of claim 26, wherein the received global portfolio optimization decision variables include one or more global optimization constraints and one or more global optimization objective functions.

28. The system of claim 27, wherein said client interface is further configured such that if said one or more of said global optimization constraints is not satisfied, said client interface adjusts each of said one or more optimization individual optimization objective functions based on each said optimized asset data and said aggregate optimization asset data.

29. The system of claim 28, wherein said client interface is further configured to re-optimize said asset data based on said adjusted decision variables.

30. The system of claim 28, wherein said client interface is further configured to adjust said one or more individual optimization objective functions using Lagrangian Relaxation and Dual Problem Techniques.

31. The system of claim 27, wherein said client interface is further configured such that if said one or more global optimization constraints are satisfied, said client interface determines if said one or more global optimization objective functions function have been satisfied.

32. The system of claim 31, wherein said client interface is further configured such that if said one or more global optimization objective functions have not been satisfied, said client interface adjusts said one or more individual optimization objective functions based on each said optimized portfolio data and said aggregate optimization asset data.

33. The system of claim 25, wherein said client interface is further configured to receive at least one of a name of an asset, a symbol of an asset, a market price of an asset, an average price at which an asset was purchased, a number of shares of an asset in one of said plurality of portfolios, and a number of shares of an asset in a plurality of portfolios.

34. The system of claim 26, wherein said client interface is further configured to receive at least one constraint defining a maximum number of shares that can be traded for said plurality of portfolios, whether “late comers” are allowed, whether “crossing” is allowed, whether “fairness” is a consideration, or a total maximum transaction cost for all portfolios, a maximum level of risk allowed.

35. The system of claim 26, wherein said client interface is further configured to receive at least one objective related to at least one of risk, return, or trading cost.

36. The system of claim 27, wherein said client interface is further configured to receive said one or more global objectives including at least one of minimization of the sum of the individual portfolio deviations, or minimization of the worst of the individual portfolio deviations.

37. The system of claim 27, further comprising a user display device for displaying the outputted said optimized asset data.

38. The system of claim 27, wherein, the outputted said optimized asset data is in the form of a trade list for transmission to a trading system.

39. A method for applying “fairness” principles to the optimization of a plurality of portfolios, each portfolio including one or more shares of one or more tradable assets, said method comprising:
a) receiving asset data defining a plurality of said portfolios;
b) receiving one or more individual portfolio optimization decision variables corresponding to one or more of said plurality of portfolios;
c) for each portfolio of said plurality of portfolios, optimizing said asset data based on a corresponding one or more of said individual optimization decision variables;
d) determining if any of said plurality of portfolios would be adversely affected by the optimization solution of any other of said plurality of portfolios;
e) adjusting said one or more individual portfolio optimization decision variables, so that said adverse affect is compensated for;
f) re-optimizing said asset data based on said adjusted one or more of said individual optimization decision variables; and
g) outputting said optimized data.
